(19) United States
(12) Patent Application Publication
(10) Pub. No.: US 2016/0358202 A1
(43) Pub. Date: Dec. 8, 2016

(54) AFFILIATED COMPANY SERVER, SERVICE PROVIDING DEVICE AND TERMINAL, ELECTRONIC WALLET SYSTEM COMPRISING THE SAME, CONTROL METHOD THEREOF AND NON-TRANSITORY COMPUTER READABLE STORAGE MEDIUM HAVING COMPUTER PROGRAM RECORDED THEREON

(71) Applicant: SK PLANET CO., LTD., Seongnam-si, Gyeonggi-do (KR)

(72) Inventor: Jong Soo Lee, Seoul (KR)

(21) Appl. No.: 14/899,054

(22) PCT Filed: Dec. 5, 2014
(86) PCT No.: PCT/KR2014/011884

§ 371 Date: Dec. 16, 2015

(30) Foreign Application Priority Data
Jan. 28, 2014 (KR) 10-2014-0010384
Feb. 11, 2014 (KR) 10-2014-0015715
Feb. 11, 2014 (KR) 10-2014-0015717
Feb. 17, 2014 (KR) 10-2014-0017658

(51) Int. Cl. G06Q 30/02

(52) U.S. Cl. CPC G06Q 30/0238; G06Q 30/0224

(57) ABSTRACT

Provided are an affiliated company server, a service providing device and a terminal, an electronic wallet system comprising the same, a control method thereof, and a non-transitory computer readable storage medium having a computer program recorded thereon. That is, according to the present invention, it is possible to improve convenience of a user and management efficiency by diversity of the coupons provided in the non-affiliated company and expand a coupon interlocking field by issuing the corresponding coupon to the terminal requesting the corresponding coupon through the service providing device and performing the usage for the corresponding coupon by interlocking with the affiliated company server when using the corresponding coupon in the terminal, after the coupon provided in the non-affiliated company is pre-registered in the coupon server.

### CROSS-REFERENCE TO RELATED APPLICATION

This application claims the benefit of Korean Application Nos. 10-2014-0010384 filed on Jan. 28, 2014, 10-2014-0015715 filed on Feb. 11, 2014, 10-2014-0015717 filed on Feb. 11, 2014 and 10-2014-0017658 filed on Feb. 17, 2014 with the Korean Intellectual Property Office, the disclosure of which is incorporated herein by reference.

### BACKGROUND OF THE INVENTION

1. Field of the Invention

The present invention relates to an affiliated company server, a service providing device and a terminal, an electronic wallet system comprising the same, a control method thereof, and a non-transitory computer readable storage medium having a computer program recorded thereon, and more particularly, to an affiliated company server, a service providing device and a terminal, an electronic wallet system comprising the same, a control method thereof, and a non-transitory computer readable storage medium having a computer program recorded thereon capable of issuing a corresponding coupon to a terminal requesting the corresponding coupon through the service providing device and performing a usage of the corresponding coupon by interlocking with the affiliated company server when the terminal uses the corresponding coupon, after the coupon provided from a non-affiliated company is pre-registered in a coupon server.

2. Description of the Related Art

An electronic wallet system is a system of managing credit cards, transportation cards, membership cards, coupons, and the like through a user terminal with a USIM card and the like and providing a payment function between the user terminal and an affiliated terminal.

In such an electronic wallet system, in the case of a non-interlocking affiliated company, since the non-interlocking affiliated company can not issue a coupon to a customer terminal subscribed in the electronic wallet system, it is uncomfortable in use and a promotional effect of the service providing device and the affiliated company server managing an electronic wallet app is impeded.

### SUMMARY OF THE INVENTION

An object of the present invention is to provide an affiliated company server, a service providing device and a terminal, an electronic wallet system comprising the same, a control method thereof, and a non-transitory computer readable storage medium having a computer program recorded thereon for issuing a corresponding coupon to a terminal requesting the corresponding coupon through the service providing device, after the coupon provided from a non-affiliated company is pre-registered in a coupon server.

Another object of the present invention is to provide an affiliated company server, a service providing device and a terminal, an electronic wallet system comprising the same, a control method thereof, and a non-transitory computer readable storage medium having a computer program recorded thereon for performing a usage for the corresponding coupon by interlocking with the affiliated company server when the corresponding coupon is used in the terminal storing the coupon issued in the non-affiliated company.

Yet another object of the present invention is to provide an affiliated company server, a service providing device and a terminal, an electronic wallet system comprising the same, a control method thereof, and a non-transitory computer readable storage medium having a computer program recorded thereon for providing a game function between terminals of friends installing a specific app such as an electronic wallet app.

Still another object of the present invention is to provide an affiliated company server, a service providing device and a terminal, an electronic wallet system comprising the same, a control method thereof, and a non-transitory computer readable storage medium having a computer program recorded thereon for issuing a plurality of coupons temporarily stored in the service providing device to a terminal as a game winner according to a game result, after respective coupons are purchased in terminals participating in the game through the coupon server to be temporarily stored in the service providing device.

Still another object of the present invention is to provide an affiliated company server, a service providing device and a terminal, an electronic wallet system comprising the same, a control method thereof, and a non-transitory computer readable storage medium having a computer program recorded thereon for providing a game function between terminals of friends installing a specific app such as an electronic wallet app.

Still another object of the present invention is to provide an affiliated company server, a service providing device and a terminal, an electronic wallet system comprising the same, a control method thereof, and a non-transitory computer readable storage medium having a computer program recorded thereon for notifying a total purchase amount for the coupons to be purchased in the terminals participating in the game to each terminal, and then paying the total purchase amount according to the game result in the terminal as the game loser, and issuing a coupon desired by each terminal by interlocking with the coupon server and the service providing device after payment.

Still another object of the present invention is to provide an affiliated company server, a service providing device and a terminal, an electronic wallet system comprising the same, a control method thereof, and a non-transitory computer readable storage medium having a computer program recorded thereon for directly generating the coupon in the first terminal and providing the generated coupon to the second terminal through the service providing device.

Still another object of the present invention is to provide an affiliated company server, a service providing device and a terminal, an electronic wallet system comprising the same, a control method thereof, and a non-transitory computer readable storage medium having a computer program recorded thereon for generating the coupon in the first terminal based on the coupon positioned around the first terminal, transmitting the generated coupon and the position information of the first terminal to the service providing device, and providing the transmitted coupon and the position information of the first terminal to the second terminal.

Still another object of the present invention is to provide an affiliated company server, a service providing device and a terminal, an electronic wallet system comprising the same, a control method thereof, and a non-transitory computer readable storage medium having a computer program recorded thereon for performing the friend setting between the second terminal getting the coupon generated in the first terminal and the corresponding first terminal, and thereafter, sharing (alternatively, issuing) the newly generated coupon therebetween when the new coupon is generated in the first terminal or the second terminal.

According to an aspect of the present invention, an affiliated company server includes: a communication unit configured to receive a coupon number of a coupon recognized through a POS terminal transmitted from the POS terminal, identification information of a terminal, and unique information of the POS terminal when using the coupon stored in the terminal; a storage unit configured to prestoring a plurality of coupons, coupon information corresponding to each coupon, and the identification information of the terminal interlocking with the coupon information; and a control unit configured to control the communication unit so as to process a usage of the coupon corresponding to the received coupon number, generate coupon processing history information of the used coupon, and transmit the generated coupon processing history information to the service providing device, in the coupon information corresponding to the plurality of prestored coupons and the identification information of the terminal.

Preferably, the coupon corresponding to the received coupon number may be a coupon registered in the coupon server in a non-affiliated company which does not interlock with the coupon server or the service providing device.

Preferably, the coupon processing history information may include payment information, coupon unique information corresponding to the used coupon number, the identification information of the terminal, and the unique information of the POS terminal.

According to another aspect of the present invention, a coupon server includes: a communication unit configured to receive coupon processing history information transmitted from an affiliated company server via a service providing device when using a coupon registered in the coupon server in a non-affiliated company which does not interlock with the coupon server or the service providing device; a storage unit configured to prestoring a plurality of coupons, coupon information corresponding to each coupon, and the identification information of the terminal interlocking with the coupon information; and a control unit configure to verify identification information of the terminal included in the received coupon processing history information in the prestored information on the plurality of coupons and the identification information of the terminal, process a usage of a coupon number and a coupon corresponding to the verified identification information of the terminal, and perform a usage synchronization function for the used coupon by interlocking with the service providing device and the terminal.

Preferably, the coupon may include the coupon number selected from coupon numbers corresponding to issuable coupons pre-registered in the coupon server.

According to yet another aspect of the present invention, a control method of an affiliated company server includes: receiving a coupon number of a coupon recognized through a POS terminal transmitted from the POS terminal, identification information of a terminal, and unique information of the POS terminal by a communication unit when using the coupon stored in the terminal; processing a usage of the coupon corresponding to the received coupon number by a control unit in coupon information corresponding to a plurality of prestored coupons and identification information of the terminal; generating coupon processing history information of the used coupon by the control unit; and transmitting the generated coupon processing history information to the service providing device by the communication unit.

According to still another aspect of the present invention, a control method of a coupon server includes: receiving coupon processing history information transmitted from an affiliated company server via a service providing device by a communication unit when using a coupon registered in the coupon server in a non-affiliated company which does not interlock with the coupon server or the service providing device; verifying the identification information of the terminal included in the received coupon processing history information by a control unit in information on a plurality of prestored coupons and identification information of the terminal; processing a usage of a coupon number and a coupon corresponding to the verified identification information of the terminal by the control unit; and performing a usage synchronization function for the used coupon by interlocking with the service providing device and the terminal.

According to still another aspect of the present invention, a computer program executing the control methods according to the aforementioned embodiments may be stored in a non-transitory computer readable storage medium having a computer program recorded thereon.

According to still another aspect of the present invention, an electronic wallet system includes: a POS terminal configured to recognize a coupon stored in a terminal when using the coupon registered in a coupon server in a non-affiliated company which does not interlock with the coupon server or a service providing device and transmit a coupon number of the recognized coupon, identification information of the terminal, and unique information of the POS terminal; an affiliated company server configured to process a usage of the coupon corresponding to the received coupon number in the coupon information corresponding to the plurality of prestored coupons and the identification information of the terminal, generate coupon processing history information of the used coupon, and transmit the generated coupon processing history information to the service providing device; a service providing device configured to transmit the coupon processing history information transmitted from the affiliated company server to the coupon server; and the coupon server configured to process a usage of the prestored coupon number and coupon corresponding to the identification information of the terminal included in the received coupon processing history information.

According to still another aspect of the present invention, a terminal includes: a communication unit configured to communicate with the outside when a preinstalled specific app is executed; a display unit configured to display a specific app execution result screen; and a control unit configured to control the display unit to display a prestored telephone directory screen when a predetermined menu is selected on the specific app execution result screen, control the communication unit to select information on one ore more participation terminals to participate in a game on the telephone directory screen displayed on the display unit, select coupon information to be provided according to a game result, and transmit identification information of the game participation terminal corresponding to the selected information on one or more participation terminals, identification information of the terminal including the display unit, and the selected coupon information to the service providing device, and control the communication unit to perform a purchase procedure of the coupon corresponding to the coupon information by interlocking with the service providing device and the coupon server, progress a game provided by the service providing device after completing the purchase procedure of the coupon, and transmit the game progressing result to the service providing device.

According to still another aspect of the present invention, a terminal includes: a communication unit configured to communicate with the outside when a preinstalled specific app is executed; a display unit configured to display a specific app execution result screen; and a control unit configured to control the display unit to display a game type information screen prestored when the predetermined menu is selected on the specific app execution result screen, control the display unit to select a game type to be progressed on the game type information screen displayed on the display unit and display a coupon list screen transmitted from the service providing device received through the communication unit, control the display unit to select purchasable coupon information to be provided according to a game result on the coupon list screen displayed on the display unit and display the prestored telephone directory screen, control the communication unit to select information on one or more participation terminals to participate in the game on the telephone directory screen displayed on the display unit and transmit the selected game type, the selected purchasable coupon information, identification information of the game participation terminal corresponding to the selected information on one or more participation terminals, and identification information of the terminal including the display unit to the service providing device, progress the game provided by the service providing device, and get a coupon purchased by a terminal corresponding to a final game loser based on the game result through the service providing device or perform a purchase procedure for a plurality of coupons to be purchased by a plurality of terminals participating in the game.

According to still another aspect of the present invention, a first terminal includes: a communication unit configured to communicate with the outside when a preinstalled specific app is executed; a coupon generation unit configured to generate the same coupon as the coupon based on a coupon positioned around the first terminal including the communication unit through the specific app; a GPS receiver configure to verify position information of the first terminal; and a control unit configured to register the generated coupon and the verified position information of the first terminal in a service providing device, control coupon information on the generated coupon and the verified position information of the first terminal to be linked to an SNS account interlocking with the first terminal, and perform a friend setting function with a second terminal getting the coupon when the coupon is issued to the second terminal based on the coupon information registered in the service providing device or linked to the SNS account.

As described above, according to the present invention, it is possible to improve convenience of the user and management efficiency by diversity of the coupons provided in the non-affiliated company by issuing the corresponding coupon to the terminal requesting the corresponding coupon through the service providing device and performing the usage for the corresponding coupon by interlocking with the affiliated company server when using the corresponding coupon in the terminal, after the coupon provided in the non-affiliated company is pre-registered in the coupon server.

Further, it is possible to expand a coupon interlocking field with the affiliated company and the non-affiliated company by performing the usage for the corresponding coupon by interlocking with the affiliated company server when using the corresponding coupon in the terminal storing the coupon issued in the non-affiliated store.

Further, it is possible to arouse a user's interest of the terminal installing the specific app such as the electronic wallet app by providing the game function between the terminals of the friends installing the specific app such as the electronic wallet app.

Further, it is possible to diversify provided contents and improve convenience of the user by issuing the plurality of coupons temporarily stored in the service providing device to the terminal of the game winner according to the game result, after the coupons are purchased through the coupon server in the terminals participating in the game to be temporarily stored in the service providing device.

Further, it is possible to arouse a user's interest of the terminal installing the specific app such as the electronic wallet app by providing the game function between the terminals of the friends installing the specific app such as the electronic wallet app.

Further, it is possible to diversify provided contents and improve convenience of the user by paying the total purchase amount according to the game result in the terminal as the game loser and issuing a coupon desired by each terminal by interlocking with the coupon server and the service providing device after payment, after the total purchase amount for the coupons to be purchased in the terminals participating in the game is notified to each terminal.

Further, it is possible to arouse a user's interest of the terminal and improve availability of the coupons by directly generating the coupon in the first terminal and providing the generated coupon to the second terminal through the service providing device.

Further, it is possible to enhance real-time usability of the coupons through the coupons based on the position information of the generated coupon and improve convenience of the usage by generating the coupon in the first terminal based on the coupon positioned around the first terminal, transmitting the generated coupon and the position information of the first terminal to the service providing device, and providing the transmitted coupon and the position information of the first terminal to the second terminal.

Further, it is possible to enhance usability of the contents by performing the friend setting between the second terminal getting the coupon generated in the first terminal and the corresponding first terminal and thereafter, sharing (alternatively, issuing) the newly generated coupon therebetween when the new coupon is generated in the first terminal or the second terminal.

### BRIEF DESCRIPTION OF THE DRAWINGS

FIG. 1 is a block diagram illustrating a configuration of an electronic wallet system according to an embodiment of the present invention.

FIG. 2 is a block diagram illustrating a configuration of the electronic wallet system according to the embodiment of the present invention.

FIG. 3 is a block diagram illustrating a configuration of an affiliated company server according to the embodiment of the present invention.

FIG. 4 is a block diagram illustrating a configuration of a coupon server according to the embodiment of the present invention.

FIG. 5 is a block diagram illustrating a configuration of a service providing device according to the embodiment of the present invention.

FIG. 6 is a block diagram illustrating a configuration of a terminal according to the embodiment of the present invention.

FIG. 7 is a block diagram illustrating a configuration of an electronic wallet system according to another embodiment of the present invention.

FIG. 8 is a block diagram illustrating a configuration of an electronic wallet system according to yet another embodiment of the present invention.

FIG. 9 is a block diagram illustrating a configuration of a first terminal according to the embodiment of the present invention.

FIG. 10 is a signal flowchart illustrating a communicating process of an electronic wallet system according to a first embodiment of the present invention.

FIG. 11 is a signal flowchart illustrating a communicating process of an electronic wallet system according to a second embodiment of the present invention.

FIG. 12 is a signal flowchart illustrating a communicating process of an electronic wallet system according to a third embodiment of the present invention.

FIG. 13 is a signal flowchart illustrating a communicating process of an electronic wallet system according to a fourth embodiment of the present invention.

FIG. 14 is a signal flowchart illustrating a communicating process of an electronic wallet system according to a fifth embodiment of the present invention.

### DETAILED DESCRIPTION OF THE PREFERRED EMBODIMENTS

It is noted that technical terms used in the present invention are used to just describe a specific embodiment and do not intend to limit the present invention. Further, if the technical terms used in the present invention are not particularly defined as other meanings in the present invention, the technical terms should be appreciated as meanings generally appreciated by those skilled in the art and should not be appreciated as excessively comprehensive meanings or excessively reduced meanings. Further, when the technical term used in the present invention is a wrong technical term that does not accurately express the spirit of the present invention, the technical term should be understood by being substituted by a technical term which can be correctly understood by those skilled in the art. In addition, a general term used in the present invention should be interpreted as defined in a dictionary or contextually, and should not be interpreted as an excessively reduced meaning.

In addition, singular expressions used in the present invention include plurals expressions unless they have definitely opposite meanings. In the present invention, it should not analyzed that a term such as “comprising” or “including” particularly includes various components or various steps disclosed in the specification and some component or some steps among them may not include or additional components or steps may be further included. In addition, terms including ordinal numbers, such as ‘first’ and ‘second’, used in the present invention can be used to describe various components, but the components should not be limited by the terms. The above terms are used only to discriminate one component from the other components. For example, a first component may be named a second component and similarly, the second component may also be named the first component, without departing from the scope of the present invention.

Hereinafter, preferable exemplary embodiment of the present invention will be described in more detail with reference to the accompanying drawings. Like reference numerals refer to like elements for easy overall understanding and a duplicated description of like elements will be omitted.

Further, in the following description, a detailed explanation of known related technologies may be omitted to avoid unnecessarily obscuring the subject matter of the present invention. Further, it is noted that the accompanying drawings are only for easily understanding the spirit of the present invention and it should not be interpreted that the spirit of the present invention is limited by the accompanying drawings.

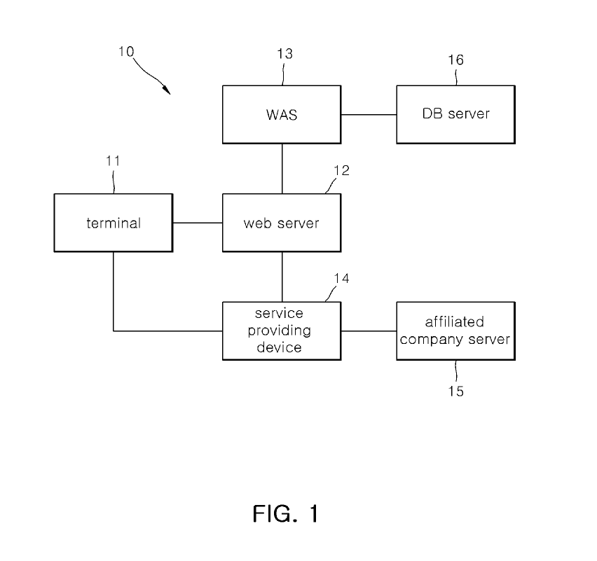

FIG. 1 is a block diagram illustrating a configuration of an electronic wallet system 10 according to an embodiment of the present invention.

As illustrated in FIG. 1, the electronic wallet system 10 is constituted by a terminal 11, a web server 12, a web application server (WAS) 13, a service providing device 14, an affiliated company server 15, and a database (DB) server 16.

All the constituent elements of the electronic wallet system 10 illustrated in FIG. 1 are not essential constituent elements, and the electronic wallet system 10 may be implemented by more constituent elements than the constituent elements illustrated in FIG. 1 or less constituent elements therethan.

The terminal 11 (alternatively, a user equipment) is identified by unique identification information such as a mobile directory number (MDN), a mobile IP, a mobile MAC, a Sim card unique information, and serial number and communicates with the web server 12 via a wired or wireless communication network. In this case, the terminal 11 receives and stores payment-related card information, coupon-related information, gift card-related information, and the like from the web server 12 and displays the corresponding information when executing a specific app or selecting a specific menu. In this case, the payment-related card information may include an image or a video for the card, an affiliated company name, a card name, a card number, an expiration date, a benefit, an annual fee, barcode information/QR code information/NFC tag information/smart tag information interlocking with the corresponding card, and the like. Further, the coupon-related information may include an affiliated company name, a coupon name, a coupon number, a benefit, a used place, a used period, a using method, and the like, and the gift card-related information may include an affiliated company name, a gift card name, a gift card number, a sum of money, a usage place, a usage period, a usage method, and the like. Further, the terminal 11 receives information related with a specific payment-related card, a coupon, a ticket, a gift card, and the like selected by the user from the service providing device 14 through the web server 12.

The web server 12 verifies information stored in the DB server 16 related with the corresponding terminal 11 through the WAS 13 based on identification information transmitted from the terminal 11 and provides the verified information to the terminal 11.

Further, when a request for issuing the payment-related card, the coupon, the ticket, the gift card, and the like is transmitted from the terminal 11, the web server 12 transmits the corresponding request to the service providing device 14 to allow the service providing device 14 to receives related information from the affiliated company server and then provide (or issue) the payment-related card, the coupon, the ticket, the gift card, and the like to the terminal 11.

As such, the web server 12 acquires and provides information stored in the DB server 16 through the WAS 13 in response to the request of the terminal 11 or provides the information transferred from the affiliated company server 15 through the service providing device 14 to the terminal 11.

The WAS 13 (alternatively, the web application server) provides the information stored in the DB server 16 to the terminal 11 through the web server 12 based on identification information of the terminal 11 transmitted from the web server 12 and furthermore, serves to distributed-process a function of the web server 12.

The service providing device 14 provides information according to the request of the terminal 11 to the terminal 11 based on the identification information of the terminal transmitted from the web server 12 or receives the corresponding information from the affiliated company server 15 and then provides the received information to the terminal 11 if necessary.

As an example, when the request for issuing the payment-related card, the coupon, the ticket, the gift card, and the like is received from the terminal 11 through the web server 12, the service providing device 14 receives the related information from the affiliated company server 15 in response to the corresponding request and then transmits the received related information to the terminal 11.

That is, when the web server 12 receives the issuance request for a specific payment-related card from the terminal 11, the web server 12 transmits the corresponding issuance request to the service providing device 14 together with the identification information of the terminal. Thereafter, the service providing device 14 issues (alternatively, transmits) the corresponding payment-related card to the terminal 11 corresponding to the identification information in response to the issuance request information for the corresponding payment-related card transmitted. In this case, the service providing device 14 receives the payment-related card from the affiliated company server 15 to provide (alternatively, transmit) the received payment-related card to the terminal 11.

The affiliated company server 15 (alternatively, an affiliated company service device) is connected with the service providing device 14 via a wired or wireless communication network, and when the issuance request of the card related with the affiliated company server 15 is transferred from the service providing device 14, a payment-related card is issued to the terminal 11 through the service providing device 14 in response to the corresponding request.

The DB sever 16 is connected with the WAS 13 through the wired or wireless communication network and stores information corresponding to the identification information of the terminal 11 (including, for example, payment-related card issuance information, payment-related card usage information, issuance information on barcode/QR code/NFC tag/smart tag, usage information on barcode/QR code/NFC tag/smart tag, point reservation/usage information, coupon issuance/usage information, and the like).

Further, the DB server 16 transmits the information on the terminal 11 corresponding to the identification information to the web server 12 through the WAS 13 in response to the request of the web server 12 including the identification information of the specific terminal 11.

Further, the electronic wallet system 10 may further include a coupon server (not illustrated) which communicates with the service providing device 14 and the affiliated company server 15.

When a coupon issuance request is received from the terminal 11, the web server 12 receives the corresponding request from the terminal 11 to transmit the received request to the service providing device 14. In addition, the service providing device 14 receives a coupon corresponding to the received request from the coupon server (alternatively, a coupon service device) to directly issue the received coupon to the terminal 11 or issue the received coupon to the terminal 11 through the web server 12. In this case, the coupon server receives (alternatively, issues) the corresponding coupon from the affiliated company server 15.

Further, the coupon server generates the corresponding coupon corresponding to the coupon issuance request (alternatively, receives the corresponding coupon from the affiliated company server 15) in response to the coupon issuance request of the web server 12 and may issue the corresponding coupon to the terminal 11 corresponding to the identification information included in the coupon issuance request.

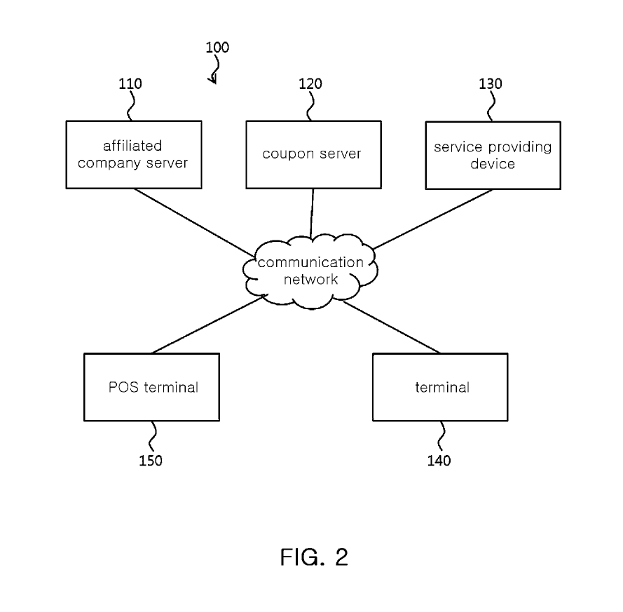

FIG. 2 is a block diagram illustrating a configuration of the electronic wallet system 100 according to the embodiment of the present invention.

As illustrated in FIG. 2, the electronic wallet system 100 is constituted by an affiliated company server 110, a coupon server 120, a service providing device 130, a terminal 140, and a POS terminal 150. All of the constituent elements of the electronic wallet system 100 illustrated in FIG. 2 are not essential constituent elements, and the electronic wallet system 100 may be implemented by more constituent elements than the constituent elements illustrated in FIG. 2 or less constituent elements therethan.

When the coupon issued in a non-affiliated company stored in the terminal 140, the POS terminal 150 recognizes the corresponding coupon and transmits a coupon number of the recognized coupon, identification information of the terminal 140 and unique information on the POS terminal 150 to the affiliated company server 110 via a communication network. Thereafter, the affiliated company server 110 processes usage of the coupon corresponding to the coupon number, generates coupon processing history information according to the usage processing, and transmitted the generated coupon processing history information to the coupon server 120 through the service providing device 130 by using the communication network. Thereafter, the coupon server 120 processes the usage of the coupon number and the coupon prestored in response to the identification information of the terminal 140 included in the corresponding coupon processing history information. Thereafter, the usage processing for the corresponding coupon stored in the coupon server 120, the service providing device 130, and the terminal 140 synchronizes with each other.

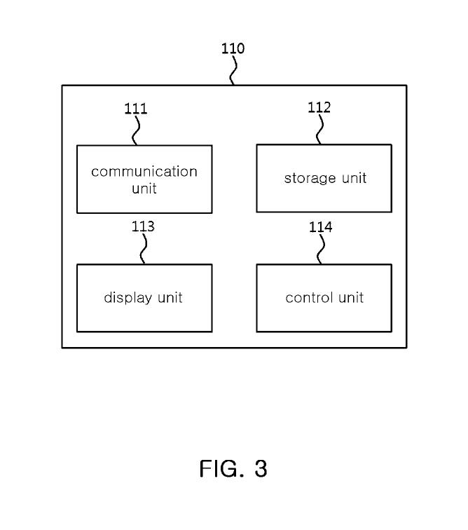

As illustrated in FIG. 3, the affiliated company server 110 is constituted by a communication unit 111, a storage unit 112, a display unit 113, and a control unit 114. All the constituent elements of the affiliated company server 110 illustrated in FIG. 3 are not essential constituent elements, and the affiliated company server 110 may be implemented by more constituent elements than the constituent elements illustrated in FIG. 3 or less constituent elements therethan.

The communication unit 111 communicates with an internal constituent element or at least one external terminal via the wired/wireless communication network. In this case, the external terminal may include the coupon server 120, the service providing device 130, the terminal 140, the POS terminal 150, and the like.

Further, the communication unit 111 directly issues (alternatively, transmits) the coupon generated by a control of the control unit 114 to the terminal 140 or transmits the coupon to the coupon server 120 and the service providing device 130.

Further, when the coupon issued to the terminal 140 is used through the POS terminal 150, the communication unit 111 receives the coupon number of the coupon transmitted from the POS terminal 150, the received identification information of the terminal 140, the unique information on the POS terminal 150, and the like.

Further, the communication unit 111 transmits processing history information on the coupon generated by the control of the control unit 114 to the service providing device 130. The storage unit 112 stores a user interface (UI), a graphic user interface (GUI), and the like.

Further, the storage unit 112 stores data, programs, and the like which are required to operate the affiliated company server 110.

Further, the storage unit 112 stores the coupon generated by the control of the control unit 114.

The display unit 113 may display contents such as a menu screen by using the UI and the GUI stored in the storage unit 112 by the control of the control unit 114. Here, the contents displayed on the display unit 113 include a menu screen including texts or image data (including various information data) and data such as icons, a list menu, and a combo box, and the like. Further, the display unit 113 may be a touch screen.

The control unit 114 executes an overall control function of the affiliated company server 110.

Further, when the affiliated company server 110 is related with the affiliated company interlocking with the coupon server 120 or the service providing device 130, the control unit 114 generates a coupon and directly issues the generated coupon to the terminal 140 or issues the generated coupon to the terminal 140 through the coupon server 120 and the service providing device 130.

Further, when the affiliated company server 110 is related with the non-affiliated company which does not interlock (alternatively, is not registered) with the coupon server 120 or the service providing device 130, the corresponding control unit 114 generates the coupon and registers the generated coupon to the coupon server 120 through the communication unit 111.

Further, the control unit 114 counts the number of coupons for each coupon type issued to the coupon server 120 or the terminal 140.

Further, the control unit 114 processes the usage of the corresponding coupon based on the coupon number of the coupon received through the communication unit 111.

That is, when the coupon issued to the terminal 140 is used through the POS terminal 150, the control unit 114 processes the usage of the corresponding coupon by executing the payment function of the corresponding coupon corresponding to the received coupon number.

Further, the control unit 114 generates the coupon processing history information on the used coupon. Here, the coupon processing history information includes payment information (for example, including an amount of payment and the like), coupon unique information corresponding to the coupon number (for example, a coupon ID), identification information of the terminal 140, unique information on the POS terminal 150, and the like.

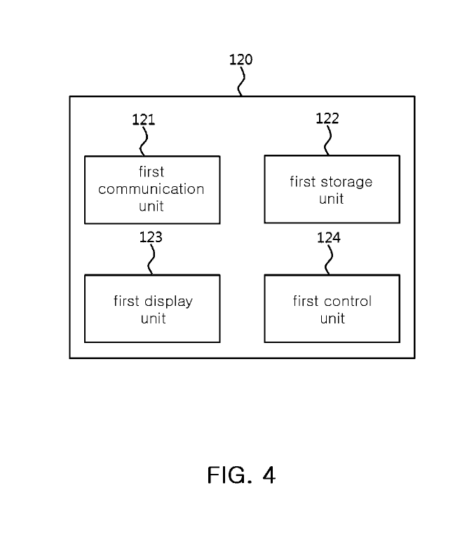

Further, the control unit 114 transmits the generated coupon processing history information to the service providing device 130 through the communication unit 111. As illustrated in FIG. 4, the coupon server 120 is constituted by a first communication unit 121, a first storage unit 122, a first display unit 123, and a first control unit 124. All the constituent elements of the coupon server 120 illustrated in FIG. 4 are not essential constituent elements, and the coupon server 120 may be implemented by more constituent elements than the constituent elements illustrated in FIG. 4 or less constituent elements therethan.

The first communication unit 121 communicates with an internal constituent element or at least one external terminal via the wired/wireless communication network. In this case, the external terminal may include the affiliated company server 110, the service providing device 130, and the like.

Further, the first communication unit 121 receives a coupon transmitted (alternatively, issued) from the affiliated company server 110. Here, the corresponding coupon may be a coupon related with an affiliated company interlocking with the coupon server 120 or the service providing device 130 or a non-affiliated company which does not interlock therewith.

Further, the first communication unit 121 receives a coupon issuance request signal including information (for example, coupon unique information) on a specific coupon transmitted from the service providing device 130, the identification information of the terminal 140, and the like.

The first storage unit 122 stores a user interface (UI), a graphic user interface (GUI), and the like.

Further, the first storage unit 122 stores data, programs, and the like required to operate the coupon server 120.

Further, the first storage unit 122 stores a coupon issued from the affiliated company server 110 by a control of the first control unit 124.

The first display unit 123 may display contents such as a menu screen by using the UI and the GUI stored in the storage unit 122 by the control of the first control unit 124. Here, the contents displayed on the first display unit 123 include a menu screen including texts or image data (including various information data) and data such as icons, a list menu, and a combo box, and the like. Further, the first display unit 123 may be a touch screen.

The first control unit 124 executes an overall control function of the coupon server 120.

Further, the first control unit 122 stores the coupon received through the first communication unit 121 in the first storage unit 122. Here, when the received coupon is a coupon issued in the non-affiliated company, the first control unit 124 sets the issuance number of the corresponding coupon and stores the set information (for example, including the issuance number, a coupon number corresponding to the issuance number, and the like) in the first storage unit 122.

Further, the first control unit 124 verifies the corresponding coupon corresponding to the coupon unique information received through the first communication unit 121, in a plurality of coupons pre-registered (alternatively, stored) in the first storage unit 122 and the coupon unique information corresponding to the coupon. In this case, the corresponding coupon corresponding to the coupon unique information may be a coupon registered in the coupon server 120 in the non-affiliated company without interlocking with the coupon server 120 or the service providing device 130.

Further, when issuable coupons corresponding to the verified coupon remains, the first control unit 124 verifies (alternatively, selects) any one coupon number among unique coupon numbers corresponding to the issuable coupons.

Further, the first control unit 124 issues (alternatively, transmits) the corresponding coupon corresponding to the verified coupon number to the service providing device 130 through the first communication unit 121.

Further, the first control unit 124 matches the identification information of the terminal 140 included in the coupon issuance request signal received through the first communication unit 121 with the coupon number corresponding to the verified coupon and stores the matched coupon number corresponding to the coupon and identification information of the terminal 140 in the first storage unit 122.

Further, the first control unit 124 stores the coupon processing history information transmitted from the service providing device 130 received through the first communication unit 121 in the first storage unit 122. Here, the coupon processing history information includes payment information (for example, including an amount of payment and the like), coupon unique information corresponding to the coupon number (for example, a coupon ID), identification information of the terminal 140, unique information (for example, an ID of the POS terminal 150) on the POS terminal 150, and the like.

Further, the first control unit 124 processes the corresponding coupon to be used based on the received coupon processing history information.

That is, the first control unit 124 verifies the identification information of the terminal 140 included in the received coupon processing history information in coupon numbers corresponding to a plurality of coupons prestored in the first storage unit 122 and the identification information of the terminal 140 and processes the coupon number corresponding to the verified identification information of the terminal 140 and the corresponding coupon to be used.

Further, the first control unit 124 synchronizes the usage processing for the coupon numbers corresponding to the corresponding coupons stored in the coupon server 120, the service providing device 130, and the terminal 140 by interlocking with the service providing device 130 and the terminal 140 through the first communication unit 121.

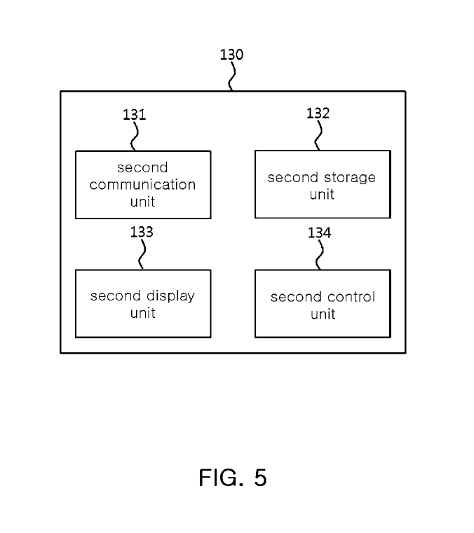

As illustrated in FIG. 5, the service providing device 130 is constituted by a second communication unit 131, a second storage unit 132, a second display unit 133, and a second control unit 134. All of the constituent elements of the service providing device 130 illustrated in FIG. 5 are not essential constituent elements, and the service providing device 130 may be implemented by more constituent elements than the constituent elements illustrated in FIG. 5 or less constituent elements therethan.

The second communication unit 131 communicates with an internal constituent element or at least one external terminal via the wired/wireless communication network. In this case, the external terminal may include the affiliated company server 110, the coupon server 120, the terminal 140, and the like.

Further, the second communication unit 131 receives the coupon issuance request signal transmitted from the terminal 140. Here, the coupon issuance request signal includes coupon information, the identification information of the terminal 140, and the like. In this case, the coupon information includes information on an affiliated company name, a coupon type, a coupon name, a benefit, a usage place, a usage period, a usage method, and the like. Further, the identification information of the terminal 140 includes an MDN, a mobile IP, a mobile MAC, Sim card unique information, a serial number, and the like of the terminal 140.

Further, when the usage for the specific coupon is completed, the second communication unit 131 receives the coupon processing history information transmitted from the affiliated company server 110. Here, the coupon processing history information includes payment information (for example, including an amount of payment and the like), coupon unique information corresponding to the coupon number (for example, a coupon ID), identification information of the terminal 140, unique information on the POS terminal 150, and the like.

The second storage unit 132 stores a user interface (UI), a graphic user interface (GUI), and the like. Further, the second storage unit 132 stores data, programs, and the like required to operate the service providing device 130.

Further, the second storage unit 132 stores a coupon issued from the coupon server 120 by a control of the second control unit 134.

The second display unit 133 may display contents such as a menu screen by using the UI and the GUI stored in the second storage unit 132 by the control of the second control unit 134. Here, the contents displayed on the second display unit 133 include a menu screen including texts or image data (including various information data) and data such as icons, a list menu, and a combo box, and the like. Further, the second display unit 133 may be a touch screen.

The second control unit 134 executes an overall control function of the service providing device 130.

Further, the second control unit 134 transmits the coupon issuance request signal transmitted from the received terminal 140 through the second communication unit 131 to coupon server 120 and requests the issuance of the coupon corresponding to the coupon information included in the coupon issuance request signal.

Further, the second control unit 134 receives the coupon including the coupon number issued from the coupon server 120 in response to the coupon issuance request through the second communication unit 131 and transmits (alternatively, issues) the received coupon to the corresponding terminal 140 through the second communication unit 131. In this case, the second control unit 134 counts the number of coupons for each coupon type issued in the terminal 140.

Further, the second control unit 134 matches the coupon number included in the received coupon with unique information on the corresponding coupon and the identification information of the terminal 140 and stores the matched information (for example, the matched coupon number, the unique information on the coupon, and the identification information of the terminal 140) in the second storage unit 132.

Further, the second control unit 134 notifies to the coupon server 120 that the terminal 140 corresponding to the identification information of the terminal 140 included in the coupon processing history information uses the coupon corresponding to the used coupon number by transmitting the received coupon processing history information to the coupon server 120 through the second communication unit 131.

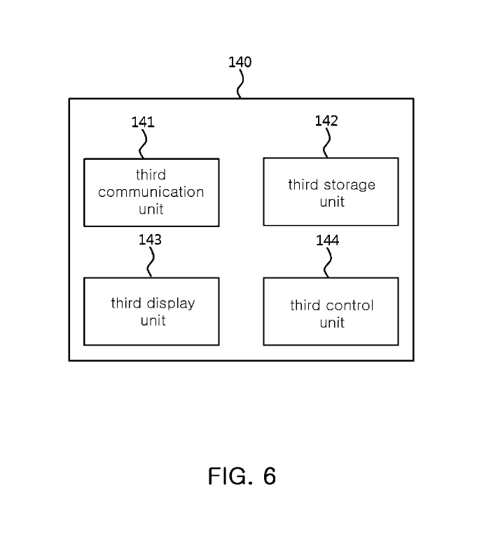

As illustrated in FIG. 6, the terminal 140 is constituted by a third communication unit 141, a third storage unit 142, a third display unit 143, and a third control unit 144. All the constituent elements of the terminal 140 illustrated in FIG. 6 are not essential constituent elements, and the terminal 140 may be implemented by more constituent elements than the constituent elements illustrated in FIG. 6 or less constituent elements therethan.

The third communication unit 141 communicates with an internal constituent element or at least one external terminal via the wired/wireless communication network. In this case, the external terminal may include the service providing device 130, the POS terminal 150, and the like.

Further, the third communication unit 141 transmits the coupon issuance request signal to the service providing device 130 by a control of the third control unit 144. The third storage unit 142 stores a user interface (UI), a graphic user interface (GUI), and the like.

Further, the third storage unit 142 stores data and programs required to operate the terminal 140.

Further, the third storage unit 142 stores (alternatively, registers) a coupon issued through the coupon server 120 and the service providing device 130 by control of the third control unit 144.

The third display unit 143 may display contents such as a menu screen by using the UI and the GUI stored in the third storage unit 142 by the control of the third control unit 144. Here, the contents displayed on the third display unit 143 include a menu screen including texts or image data (including various information data) and data such as icons, a list menu, and a combo box, and the like. Further, the third display unit 143 may be a touch screen. The third control unit 144 executes an overall control function of the terminal 140.

Further, when a specific app such as an electronic wallet or digital wallet app pre-installed in the third storage unit 142 is executed, the third control unit 144 displays a specific app execution result screen corresponding to the specific app on the third display unit 143. Here, the specific app execution result screen includes a my-wallet menu, an add menu, an event/news menu, a more-view menu, and the like. In this case, the more-view menu includes an activity-point menu, a housekeeping book menu, a point integrated inquiry menu, a social network service (SNS)-related menu, and the like. In this case, the my-wallet menu is a menu storing information on the payment-related card, the coupon, the ticket, the gift card, and the like, which is installed or registered in the terminal 140 through the specific app. Further, the add menu is a menu for newly getting the payment-related card, the coupon, the ticket, other classification items through the specific app. Further, the event/news menu is a menu for verifying information on events or notices and the like transmitted from the service providing device and the like. Further, the activity-point menu is a menu for providing activity points interlocking with a plurality of predetermined apps and information on a plurality of apps or related companies which may use related activity points. Further, the housekeeping book menu is a menu (alternatively, a housekeeping book-dedicated app) for providing information on a usage history of the card registered in a membership item of the my-wallet menu, a point usage history, and the like in a housekeeping book form. Further, the point integrated inquiry menu is a menu representing point information on the card registered in the membership item of the my-wallet menu. Further, the SNS-related menu is a facebook site-related menu interlocking with the specific app.

Further, when the specific app is executed, the third control unit 144 identifies the terminal 140 through unique identification information such as the MDN, the mobile IP, the mobile MAC, the Sim card unique information, and a serial number of the terminal 140 and communicates with the service providing device 130 via the wired or wireless communication network. In this case, the third control unit 144 transmits the identification information of the terminal 140 to the service providing device 130 in a background state, and the service providing device 130 identifies the terminal 140 based on the identification information and communicates with the terminal 140.

Further, when the specific coupon is selected from the specific app execution result screen displayed on the third display unit 143, the third control unit 144 generates a coupon issuance request signal for requesting issuance of the selected coupon. Here, the coupon issuance request signal includes coupon information, the identification information of the terminal 140, and the like. In this case, the coupon information includes information on an affiliated company name, a coupon type, a coupon name, a benefit, a usage place, a usage period, a usage method, and the like. Further, the identification information of the terminal 140 includes an MDN, a mobile IP, a mobile MAC, Sim card unique information, a serial number, and the like of the terminal 140.

Further, the third control unit 144 transmits the generated coupon issuance request signal to the service providing device 130 through the third communication unit 141.

Further, the third control unit 144 receives the corresponding coupon issued from the service providing device 130 in response to the transmitted coupon issuance request signal through the third communication unit 141 and stores (alternatively, registers) the received coupon in the third storage unit 142. In this case, the third control unit 144 stores the coupon number for the corresponding coupon in the third storage unit 142.

Further, in the case of using a specific coupon registered (alternatively, stored) in the third storage unit 142 in the specific app execution result screen display on the third display unit 143, the corresponding specific coupon is recognized and processed through the POS terminal 150. Here, the coupon may be a barcode form, a QR code form, a smart tag form, an NFC tag form, or the like. Further, the third control unit 144 synchronizes the usage processing for the corresponding specific coupon by interlocking with the coupon server 120 and the service providing device 130.

That is, the third control unit 144 processes the usage of the corresponding specific coupon to delete the corresponding specific coupon registered in the third storage unit 142.

When using the coupon stored in the terminal 140, the POS terminal 150 recognizes the coupon stored in the terminal 140 through a reader (not illustrated) included in the POS terminal 150. Here, the coupon may be a barcode form, a QR code form, a smart tag form, an NFC tag form, or the like. Further, the corresponding coupon, as a coupon registered in the coupon server 120 in a non-affiliated company without interlocking with the coupon server 120 or the service providing device 130, may be a coupon issued in the corresponding terminal 140 by the issuance request of the terminal 140 after setting the issuance number of the corresponding coupon in the coupon server 120 and storing the set information (for example, including the issuance number, a coupon number corresponding to the issuance number, and the like) when the non-affiliated company registers the corresponding coupon in the coupon server 120. Further, the reader may be a barcode reader, a QR code reader, a smart tag reader, an NFC reader, and the like for recognizing different types (for example, a barcode type, a QR code type, a smart tag type, an NFC tag type, and the like) of coupons. In this case, when recognizing the coupon stored in the terminal 140, the POS terminal 150 may communicate with the terminal 140 via the wired or wireless communication network in a background state. Further, the POS terminal 150 receives the identification information of the terminal 140 transmitted from the terminal 140. Here, the identification information includes an MDN, a mobile IP, a mobile MAC, Sim card unique information, a serial number, and the like of the terminal 140.

Further, the POS terminal 150 transmits a coupon number of the recognized coupon, identification information of the received terminal 140, unique information on the POS terminal 150, and the like to the affiliated company server 110. Here, the affiliated company server 110 may be a non-affiliated company server issuing the corresponding coupon.

As such, after the coupon provided in the non-affiliated company is pre-registered in the coupon server, the corresponding coupon is issued to the terminal requesting the corresponding coupon through the service providing device and the terminal may perform the usage for the corresponding coupon by interlocking with the affiliated company server when using the corresponding coupon.

Further, as such, when using the corresponding coupon in the terminal storing the coupon issued in the non-affiliated company, the usage for the corresponding coupon may be performed by interlocking with the affiliated company server.

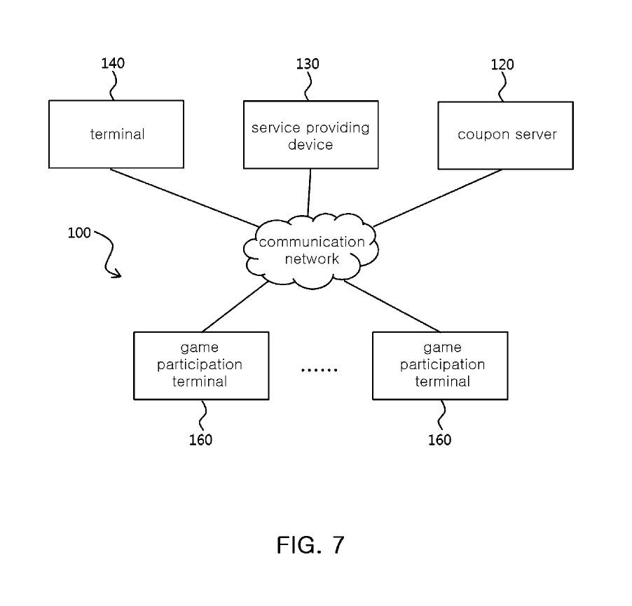

FIG. 7 is a block diagram illustrating a configuration of an electronic wallet system 100 according to another embodiment of the present invention.

As illustrated in FIG. 7, the electronic wallet system 100 is constituted by a terminal 140, a service providing device 130, one or more game participation terminals 160, and a coupon server 120. All of the constituent elements of the electronic wallet system 100 illustrated in FIG. 7 are not essential constituent elements, and the electronic wallet system 100 may be implemented by more constituent elements than the constituent elements illustrated in FIG. 7 or less constituent elements therethan.

When a predetermined all-at-once service (alternatively, a predetermined function/menu) included in a specific app such as an electronic wallet app preinstalled in the terminal 140 is selected, the terminal 140 transmits participation terminal information, identification information of the terminal 140, and coupon information to the service providing device 130 via the communication network. Thereafter, the service providing device 130 transmits a game participation push message including the coupon information to the game participation terminal 160 corresponding to information on a participation terminal to participate in the game via the communication network. Thereafter, each game participation terminal 160 performs an issuance procedure for the coupon corresponding to the coupon information by interlocking with the service providing device 130 and the coupon server 120 based on the game participation push message. Thereafter, when the issuance procedure (alternatively, a coupon purchasing procedure) is completed, the service providing device 130 temporarily stores a plurality of coupons issued from the coupon server 120 and collects game playing and a game result for terminals participating in the game via the communication network. Thereafter, the service providing device 130 selects a terminal corresponding to a final winner based on the collected game result and issues a plurality of coupons which is temporarily stored in the terminal corresponding to the selected final winner via the communication network.

The third communication unit 141 communicates with an internal constituent element or at least one external terminal via the wired/wireless communication network. In this case, the external terminal may include the service providing device 130, the game participation terminal 160, the coupon server 120, and the like.

Further, the third communication unit 141 performs a coupon issuance (alternatively, coupon purchase) function by interlocking with the service providing device 130 and the coupon server 120 by a control of the third control unit 144.

Further, when a specific app such as an electronic wallet or digital wallet app installed in the terminal 140 is executed, the third control unit 144 displays an execution result screen on the third display unit 143.

Further, when the specific app is executed, the third control unit 144 identifies the terminal 144 through unique identification information such as the MDN, the mobile IP, the mobile MAC, the Sim card unique information, and the serial number and communicates with the service providing device 130 via the wired or wireless communication network. In this case, the third control unit 144 transmits the identification information of the terminal 140 to the service providing device 130 in a background state, and the service providing device 130 identifies the terminal 140 based on the identification information and communicates with the terminal 140. Here, the identification information includes an MDN, a mobile IP, a mobile MAC, Sim card unique information, a serial number, and the like of the terminal 140.

Further, when a predetermine all-at-once service (alternatively, a predetermined function/menu) is selected in the specific app execution result screen displayed on the third display unit 143, the third control unit 144 displays a first screen corresponding to the selected predetermine all-at-once service on the third display unit 143. Here, the first screen may be a coupon list screen transmitted from the service providing device 130 received through the third communication unit 141 in order to select a telephone directory screen or coupon information which is pre-stored in the third storage unit 142 for selecting participation terminal information. Here, the coupon list screen includes a plurality of coupon information. Further, the coupon information includes information on an affiliated company title (alternatively, an affiliated company name) issuing a coupon, a coupon name, a unique code (alternatively, a coupon number), a title, a benefit, a usage place, a usage period (alternatively, an expiration date), a usage method, a coupon type (for example, a free coupon or a paid coupon), and the like.

That is, when the predetermine all-at-once service is selected in the specific app execution result screen displayed on the third display unit 143, the third control unit 144 displays the telephone directory screen pre-stored in the third storage unit 142 on the third display unit 143 in order to select information on a participation terminal to participate in the game corresponding to the corresponding all-at-once service. Thereafter, the third control unit 144 verifies information on one or more participation terminals selected from the telephone directory screen displayed on the third display unit 143. In this case, the verified participation terminal information may include identification information of the game participation terminal 160 or a name/nickname and the like which are stored in the terminal 140 corresponding to the identification information of the game participation terminal 160. Further, the third control unit 144 displays on the third display unit 143 a coupon list screen including information on a plurality of coupons transmitted from the service providing device 130 in order to select the coupon to be provided to the final winner terminal through the corresponding all-at-once service to be received through the third communication unit 141. Thereafter, the third control unit 144 verifies coupon information selected from the coupon list screen displayed on the third display unit 143. In this case, the coupon information selected from the coupon list screen may be one or in plural. Further, the third control unit 144 displays information on game types (for example, including a rock-paper-scissors game, a dice game, a ladder game, and the like) to be proceeded through the corresponding all-at-once service on the third display unit 143. Thereafter, the third control unit 144 verifies information on any one game type selected from the information on game types displayed on the third display unit 143.

Further, the third control unit 144 transmits the verified participation terminal information (alternatively, the identification information of the game participation terminal 160), the identification information of the terminal 140, and the coupon information to the service providing device 130 through the third communication unit 141. In this case, the third control unit 144 may also transmit the verified game type information to the service providing device 130 together with the participation terminal information, the identification information of the terminal 140, and the coupon information.

Further, the third control unit 144 performs a purchase procedure for the coupon to be provided to the final winner terminal through the corresponding all-at-once service by interlocking with the service providing device 130 and the coupon server 120 through the third communication unit 141.

Further, after the coupon purchasing procedure is completed in all terminals participating in the all-at-once service, the third control unit 144 proceeds the game provided from the service providing device 130. In this case, the game provided from the service providing device 130 may be a game interlocking with a specific app such as an electronic wallet app.

Further, the third control unit 141 transmits result information of the corresponding game to the service providing device 130 through the third communication unit 144.

Further, when being selected as the final winner terminal of the game progressing through the all-at-once service, the third control unit 144 stores (alternatively, registers/interlocks) a plurality of coupons issued from the service providing device 130 through the third communication unit 141 in the specific app such as the electronic wallet app.

Further, when not being selected as the final winner terminal of the game progressing through the all-at-once service, the third control unit 144 receives information on the final game winner transmitted from the service providing device 130 through the third communication unit 141 (alternatively, the identification information of the terminal corresponding to the final game winner) and a coupon issuance completion guidance message including coupon issuance completion information and the like and displays the received coupon issuance completion guidance message on the third display unit 143.

The second communication unit 131 communicates with an internal constituent element or at least one external terminal via the wired/wireless communication network. In this case, the external terminal may include the terminal 140, the game participation terminal 160, the coupon server 120, and the like.

Further, the second communication unit 131 receives the identification information of the terminal 140 transmitted from the terminal 140 by the control of the second control unit 134.

Further, the first communication unit 131 receives the information on one or more participation terminals (alternatively, the identification information of the game participation terminals 160), the identification information of the terminal 140, and the coupon information, which are transmitted from the terminal 140 by the control of the second control unit 134.

The second storage unit 132 temporarily stores a plurality of coupons issued from the coupon server 120 through the second communication unit 131 by a control of the second control unit 134.

The second control unit 134 generates a game participation push message including information on a game hosted in the terminal 140, information on a coupon to be provided through the corresponding game, information on a participation terminal to participate in the corresponding game, the identification information of the terminal 140, and the like.

Further, the second control unit 134 transmits the generated game participation push message to one or more game participation terminals 160 corresponding to the received information on one or more participation terminals through the second communication unit 131, respectively.

Further, the second control unit 134 communicates with the game participation terminals 160 participating in the corresponding game through the second communication unit 131 in response to the transmitted game participation push message.

Further, the second control unit 134 performs a purchase procedure for the coupon to be provided to the final winner terminal through the corresponding all-at-once service of the game participation terminals 160 participating in the corresponding game by interlocking with the game participation terminals 160 and the coupon server 120.

Further, the second control unit 134 performs a purchase procedure for the coupon to be provided to the final winner terminal through the corresponding all-at-once service of the terminals 140 by interlocking with the terminal 160 and the coupon server 120.

Further, when the coupon purchasing procedure for the terminal 140 participating in the game to progress through the all-at-once service within a predetermined time and one or more game participation terminals 160 is completed, the second control unit 134 temporarily stores in the second storage unit 132 the plurality of coupons issued from the coupon server 120 which is purchased in the terminal 140 participating in the game and one or more game participation terminals 160.

Further, when the coupon purchasing procedure is completed in the terminals 140 and 160 to participate in the game progressing through the all-at-once service within the predetermined time, the second control unit 134 progresses the game between the terminals 140 and 160 participating in the game and collects the corresponding game result. In this case, the progressing game may be a game which is randomly selected in a plurality of games prestored in the second control unit 134 or set in the terminal 140.

Further, the second control unit 134 selects the terminal corresponding to the final game winner based on the collected game result. In this case, the second control unit 134 may also set a terminal corresponding to any one of the top, the bottom, and a predetermined rank in the game rank as the final game winner.

Further, the second control unit 134 issues the plurality of coupons temporarily stored in the second storage unit 132 to the terminal corresponding to the selected final game winner.

Further, the second control unit 134 generates a coupon issuance completion guidance message including information on the final game winner (alternatively, the identification information of the terminal corresponding to the final game winner), the coupon issuance completion information, and the like.

Further, the second control unit 134 transmits the generated coupon issuance completion guidance message to the remaining terminals except for the terminal corresponding to the final game winner among the terminals participating in the game through the second communication unit 131.

As such, the service providing device 130 performs a temporary storage function of coupons issued according to the all-at-once service, a game management function, a game rank selection function, a function of issuing the coupons temporarily stored in the terminal corresponding to the game winner, a function of transmitting the coupon issuance completion guidance message.

The game participation terminal 160 may be formed by the components (for example, including the communication unit, the storage unit, the display unit, the control unit, and the like) such as the terminal 140 described above and the description for like components and functions will be omitted.

Further, the game participation terminal 160 receives a game participation push message including the coupon information transmitted from the service providing device 130. Here, the game participation push message includes information on a game hosted in the terminal 140, information on a coupon to be provided through the corresponding game, information on a participation terminal to participate in the corresponding game, the identification information of the terminal 140, and the like.

Further, the game participation terminal 160 displays the received game participation push message.

Further, when the coupon information included in the displayed game participation push message is selected or a predetermined button is selected, the game participation terminal 160 performs a purchasing procedure for the coupon to be provided to the final winner terminal through the corresponding all-at-once service by interlocking with the service providing device 130 and the coupon server 120.

Further, after the purchasing procedure for the coupon to be provided to the final winner terminal is completed through the corresponding all-at-once service, the game participation terminal 160 progresses the game to be provided from the service providing device 130. In this case, the game provided from the service providing device 130 may be a game interlocking with a specific app such as an electronic wallet app.

Further, the game participation terminal 160 transmits result information of the corresponding game to the service providing device 130.

Further, when the game participation terminal 160 is selected as the final winner terminal of the game progressed through the all-at-once service, the game participation terminal 160 stores (alternatively, registers/interlocks) the plurality of coupons issued from the service providing device 130 in the specific app such as the electronic wallet app.

Further, when the game participation terminal 160 is not selected as the final winner terminal of the game progressed through the all-at-once service, the game participation terminal 160 receives information on the final game winner transmitted from the service providing device 130 (alternatively, the identification information of the terminal corresponding to the final game winner) and a coupon issuance completion guidance message including coupon issuance completion information and the like and outputs the received coupon issuance completion guidance message.

The coupon server 120 communicates with the terminal 140, the service providing device 130, the game participation terminal 160, and the like.

Further, the coupon server 120 generates the coupon and performs a function of issuing the generated coupon to the terminal. In this case, when the game is progressed by interlocking between the service providing device 130, the terminal 140 and the game participation terminal 160, the coupon server 120 issues the coupons purchased through the terminal 140 and the game participation terminal 160 to the service providing device 130. In this case, the issued coupon may be a coupon corresponding to the coupon information transmitted from the service providing device 130. Here, the coupon information includes information on an affiliated company title (alternatively, an affiliated company name) issuing a coupon, a coupon name, a unique code (alternatively, a coupon number), a title, a benefit, a usage place, a usage period (alternatively, an expiration date, a usage method, a coupon type (for example, a free coupon or a paid coupon), and the like.

Further, the coupon server 120 matches the terminal 140 purchasing the coupon or the identification information of the game participation terminal 160 with the coupon information on the purchased coupon and stores the matched information.

Further, the coupon server 120 counts the number of coupons issued in the service providing device 130 according to the purchase of the terminal 140 or the game participation terminal 160.

As such, a game function may be provided between terminals of friends installing the specific app such as the electronic wallet app.

Further, as such, after the coupons are purchased through the coupon server in the terminals participating in the game to be temporarily stored in the service providing device, the plurality of coupons temporarily stored in the service providing device may be issued to the terminal of the game winner according to the game result.

Further, as illustrated in FIG. 7, the electronic wallet system 100 is constituted by a terminal 140, a service providing device 130, one or more game participation terminals 160, and a coupon server 120. All of the constituent elements of the electronic wallet system 100 illustrated in FIG. 7 are not essential constituent elements, and the electronic wallet system 100 may be implemented by more constituent elements than the constituent elements illustrated in FIG. 7 or less constituent elements therethan.

When a predetermined menu included in a specific app such as an electronic wallet app preinstalled in the terminal 140 is selected, the terminal 140 transmits a game type, purchasable coupon information, participation terminal information, and identification information of the terminal 140 to the service providing device 130 via the communication network. Thereafter, the service providing device 130 transmits a push message including the game type, the purchasable coupon information, and the like to the game participation terminal 160 corresponding to information on a participation terminal to participate in the game via the communication network. Thereafter, each game participation terminal 160 replies information on a coupon to be purchased in each terminal based on the push message to transmit the replayed coupon information to the service providing device 130 via the communication network. Thereafter, the service providing device 130 calculates a total purchase amount for the plurality of coupons based on the coupon information transmitted from the terminals 140 and 160 to participate in the game and transmits the calculated total purchase amount to the terminals 140 and 160 to participate in the game via the communication network. Thereafter, the service providing device 130 collects the game progress and the game result for the terminal participating in the game via the communication network. Thereafter, the service providing device 130 selects a terminal corresponding to a final game loser based on the collected game result and performs a payment function for the plurality of coupons through the terminal corresponding to the selected final game loser. Thereafter, when the payment is completed through the terminal corresponding to the final game loser, the service providing device 130 issues the plurality of coupons issued from the coupon server 120 to the terminals 140 and 160 participating in the game via the communication network, respectively. Thereafter, when the corresponding coupon is used in the terminal getting the corresponding coupon, a push message including a gratitude greeting message is transmitted to the terminal corresponding to the final game loser via the communication network.

The third communication unit 141 receives information including the total purchase amount transmitted from the service providing device 130 by the control of the third control unit 144.

When a predetermined menu (for example, a predetermined function/service) is selected in the specific app execution result screen displayed on the display unit 143, the third control unit 144 displays a first screen corresponding to the selected predetermined menu on the third display unit 143. Here, the first screen may be a game type information screen prestored in the third storage unit 142 in order to select the game type, a coupon list screen transmitted from the service providing device 130 received through the third communication unit 141 in order to display the purchasable coupon information, a telephone directory screen prestored in the third storage unit 142 in order to select the participation terminal information, and the like. Here, the purchasable coupon information includes information on a plurality of coupons. Further, the coupon information includes information on an affiliated company title (alternatively, an affiliated company name) issuing a coupon, a coupon name, a unique code (alternatively, a coupon number), a title, a benefit, a usage place, a usage period (alternatively, an expiration date, a usage method, a coupon type (for example, a free coupon or a paid coupon), and the like.

That is, when the predetermined menu is selected on the specific app execution result screen displayed on the third display unit 143, the third control unit 144 displays on the third display unit 143 a game type information screen prestored in the third storage unit 142 (alternatively, a game type information screen transmitted from the service providing device 130 received through the third communication unit 141) in order to select the game type (for example, including a rock-paper-scissors game, a dice game, a ladder game, and the like) corresponding to the corresponding menu. Thereafter, the third control unit 144 verifies a plurality (one or more) of game types selected from the game type information screen displayed on the third display unit 143. Thereafter, the third control unit 144 displays on the third display unit 143 a coupon list screen including information on the plurality of coupons transmitted from the service providing device 130 to be received through third communication unit 141 from the service providing device 130 in order to select the coupon to be purchased by the terminal 140 through the corresponding menu. Thereafter, the third control unit 144 verifies information on a plurality of purchasable coupons selected from the coupon list screen displayed on the third display unit 143. Thereafter, the third control unit 144 displays the telephone directory screen prestored in the third storage unit 142 on the third display unit 143 in order to select information on participation terminals to participate in the game corresponding to the corresponding menu. Thereafter, the third control unit 144 verifies information on one or more participation terminals selected from the telephone directory screen displayed on the third display unit 143. In this case, the verified participation terminal information may include identification information of the game participation terminal 160 or a name/nickname and the like which are stored in the terminal 140 corresponding to the identification information of the game participation terminal 160.

Further, the third control unit 144 transmits the verified game type, the purchasable coupon information, the participation terminal information (alternatively, the identification information of the game participation terminal 160), and the identification information of the terminal 140 to the service providing device 130 through the third communication unit 141.

Further, the third control unit 144 displays information including a total purchase amount received through the third communication unit 141 on the third display unit 143. Here, the total purchase amount may be a total amount of coupon prices for the plurality of coupons to be purchased by the terminals 140 and 160 to participate in the game.

Further, after the replying procedure for the coupon information is completed in all of the terminals participating in the game, the third control unit 144 progresses the game provided from the service providing device 130. In this case, the game provided from the service providing device 130 may be a game interlocking with a specific app such as an electronic wallet app.

Further, the third control unit 144 transmits result information of the corresponding game to the service providing device 130 through the third communication unit 141.

Further, when the terminal is not selected as the final loser terminal of the game corresponding to the predetermined menu, that is, is not the terminal corresponding to the last rank of the game as the game result, the third control unit 144 stores (alternatively, registers/interlocks) coupons issued from the service providing device 130 through the third communication unit 141 in the specific app such as the electronic wallet app. In this case, the coupon registered in the specific app may be a coupon purchased in the terminal selected as the final loser among the terminals participating in the game. Further, in the coupon registered in the specific app, information on the terminal selected as the corresponding final loser (for example, the identification information of the terminal selected as the final loser) may be included.

Further, when the corresponding coupon stored in the specific app is used, the third control unit 144 transmits the push message including the gratitude greeting massage to the terminal as the final game loser purchasing the corresponding coupon through the third communication unit 141. In this case, the push message including the gratitude greeting massage may also be transmitted to the terminal as the final game loser through the service providing device 130.

Further, when the terminal is selected as the final loser terminal of the game corresponding to the predetermined menu, the third control unit 144 receives the information on the plurality of coupons to be purchased by the terminals 140 and 160 participating in the game transmitted from the service providing device 130 through the third communication unit 141 and displays the received information on the plurality of coupons on the third display unit 143.

Further, the third control unit 144 performs a purchase procedure for the plurality of coupons to be provided to the terminals participating in the game through the corresponding game by interlocking with the service providing device 130 and the coupon server 120 through the third communication unit 141.

The second communication unit 131 receives the identification information of the terminal 140 transmitted from the terminal 140 by the control of the second control unit 134.

Further, the second communication unit 131 receives the game type, the purchasable coupon information, the information on one or more participation terminals, and the identification information of the terminal 140 which are transmitted from the terminal 140 by the control of the second control unit 134.

The second storage unit 132 temporarily stores the information on each coupon transmitted from the terminals 140 and 160 to participate in the game received through the second communication unit 131 by the control of the second control unit 134 and the identification information of the terminal transmitting the coupon information.

The second control unit 134 generates a push message including information on a game hosted in the terminal 140 (alternatively, a game type), information on a purchasable coupon to be provided through the corresponding game, information on a participation terminal to participate in the corresponding game (alternatively, the identification information of the game participation terminal 160 to participate in the corresponding game), the identification information of the terminal 140, and the like based on the game information, the participation terminal information, and the purchasable coupon information received in order to guide and induce the game participation.

Further, the second control unit 134 transmits the generated push message to one or more game participation terminals 160 corresponding to the received information on one or more participation terminals through the second communication unit 131, respectively.

Further, the second control unit 134 receives through the second communication unit 131 a replay message (for example, including coupon information selected from the coupon information purchasable in the game participation terminal 160) transmitted from the game participation terminal 160 participating in the corresponding game in response to the transmitted push message.

Further, the second control unit 134 receives the coupon information selected from the purchasable coupon information transmitted from the terminal 140 through the second communication unit 131.

Further, the second control unit 134 temporarily stores in the second storage unit 132 the coupon information transmitted from the terminals 140 and 160 participating in the game and the identification information of the terminals 140 and 160 transmitting the corresponding coupon information.

Further, when the coupon information transmitted from the terminals 140 and 160 participating in the game is received within a predetermined time, the second control unit 134 computes (alternatively, calculates) the total purchase amount of the plurality of coupons corresponding to the coupon information transmitted from the terminals participating in the game (for example, including the terminal 140 and one or more game participation terminals 160), respectively.

That is, the second control unit 134 calculates information on the total purchase amount of the plurality of coupons to be provided to the respective terminals when participating in the game.

Further, the second control unit 134 transmits the calculated information on the total purchase amount to the terminals 140 and 160 participating in the game through the second communication unit 131, respectively.

Further, when the reply procedure for the coupon information is completed in the terminals 140 and 160 participating in the game (alternatively, it is a predetermined time), the second control unit 134 progresses the game between the terminals 140 and 160 participating in the game and collects the corresponding game result. In this case, the corresponding game is not limited to the game set in the terminal 140, and may be a game which is randomly selected from the plurality of games prestored in the service providing device 130 or another game participation terminal 160 or a game selected from the plurality of games.

Further, the second control unit 134 selects the terminal corresponding to the final game loser based on the collected game result. In this case, the second control unit 134 may also set a terminal corresponding to any one of the top rank, the last rank, and a predetermined rank in the game rank as the final game winner.

That is, the second control unit 134 selects the terminal corresponding to the final game loser (the last rank) among the terminal 140 and one or more game participation terminals 160 participating in the game based on the collected game result.

Further, the second control unit 134 performs the purchase procedure (alternatively, the payment function) for the plurality of coupons to be issued to the terminals 140 and 160 participating in the corresponding game by interlocking with the terminal corresponding to the selected final game loser and the coupon server 120.

When the purchase procedure for the plurality of coupons is completed through the terminal corresponding to the final game loser, the second control unit 134 receives the plurality of coupons purchasing by the terminal as the final game loser which is issued from the coupon server 120 through the second communication unit 131. Here, information on the terminal as the final game loser may be included in each of the plurality of coupons.

Further, the second control unit 134 issues the plurality of coupons issued from the coupon server 120 to the corresponding terminals 140 and 160 based on the coupon information to be purchased in each of the terminals 140 and 160 which are temporarily stored in the second storage unit 132, respectively.

Further, when the coupon issued through the corresponding game is used in each of the terminals 140 and 160, the corresponding terminals 140 and 160 using the coupon or the second control unit 134 transmit(s) the push message including the gratitude greeting message to the terminal as the final game loser purchasing the corresponding coupon.

As such, the service providing device 130 performs the storage of the information on the plurality of coupons according to the predetermined menu, calculation and transmission of the total purchase amount for the plurality of coupons corresponding to the information on the plurality of coupons, the game management function, the game rank selection function, the payment function for the plurality of coupons to the terminal corresponding to the game loser, the coupon issuance function to the terminals participating in the game, and the like.

The game participation terminal 160 receives the push message transmitted from the service providing device 130. Here, the push message includes information on a game hosted in the terminal 140, information on a purchasable coupon to be provided through the corresponding game, information on a participation terminal to participate in the corresponding game (alternatively, identification information of the game participation terminal to participate in the corresponding game), the identification information of the terminal 140, and the like.

Further, the game participation terminal 160 displays the received push message.

Further, in the case of participating in the corresponding game, the game participation terminal 160 selects information on one coupon from the information on the purchasable coupons included in the displayed push message and transmits the selected coupon information to the service providing device 130.

Further, the game participation terminal 160 receives information including the total purchase amount transmitted from the service providing device 130 and displays the received information including the total purchase amount. Here, the total purchase amount may be a total amount of coupon prices for the plurality of coupons to be purchased by the terminals 140 and 160 to participate in the game, respectively.

Further, after the replying procedure for the coupon information is completed in all of the terminals participating in the game, the game participation terminal 160 progresses the game provided from the service providing device 130. In this case, the game provided from the service providing device 130 may be a game interlocking with a specific app such as an electronic wallet app.

Further, the game participation terminal 160 transmits result information of the corresponding game to the service providing device 130.

Further, when the terminal is not selected as the final loser terminal of the game corresponding to the predetermined menu, that is, is not the terminal corresponding to the last rank of the game as the game result, the game participation terminal 160 stores (alternatively, registers/interlocks) coupons issued from the service providing device 130 in the specific app such as the electronic wallet app. In this case, the coupon registered in the specific app may be a coupon purchased in the terminal selected as the final loser among the terminals participating in the game. Further, in the coupon registered in the specific app, information on the terminal selected as the corresponding final loser (for example, the identification information of the terminal selected as the final loser) may be included.

Further, when the corresponding coupon stored in the specific app is used, the game participation terminal 160 transmits the push message including the gratitude greeting message to the terminal as the final game loser purchasing the corresponding coupon. In this case, the push message including the gratitude greeting massage may also be transmitted to the terminal as the final game loser through the service providing device 130.

Further, when the terminal is selected as the final loser terminal of the game corresponding to the predetermined menu, the game participation terminal 160 receives the information on the plurality of coupons to be purchased by the terminals 140 and 160 participating in the game transmitted from the service providing device 130 and displays the received information on the plurality of coupons.

Further, the game participation terminal 160 performs a purchase procedure for the plurality of coupons to be provided to the terminals participating in the game through the corresponding game by interlocking with the service providing device 130 and the coupon server 120.

Further, when the purchase procedure for the plurality of coupons is completed, the corresponding game participation terminal 160 selected as the final loser terminal of the game stores the coupon issued from the coupon server 120 in the specific app via the service providing device 130.

The coupon server 120 communicates with the terminal 140, the service providing device 130, the game participation terminal 160, and the like.

Further, the coupon server 120 generates the coupon and performs a function of issuing the generated coupon to the terminal. In this case, when the game is progressed by interlocking between the service providing device 130, the terminal 140 and the game participation terminal 160, the coupon server 120 issues the plurality of coupons purchased through the terminal corresponding to the game loser as the game result to the service providing device 130. In this case, the plurality of issued coupons may be a coupon corresponding to the information on the plurality of coupons transmitted from the service providing device 130. Here, the coupon information includes information on an affiliated company title (alternatively, an affiliated company name) issuing a coupon, a coupon name, a unique code (alternatively, a coupon number), a title, a benefit, a usage place, a usage period (alternatively, an expiration date, a usage method, a coupon type (for example, a free coupon or a paid coupon), and like. Further, in the issued coupon, the information on the terminal selected as the final loser of the corresponding game (for example, the identification information of the terminal selected as the final loser) may be included.

Further, the coupon server 120 matches the terminal 140 purchasing the coupon or the identification information of the game participation terminal 160 with the information on the plurality of coupons and stores the matched information.

Further, the coupon server 120 counts the number of coupons issued in the service providing device 130 according to the purchase of the terminal 140 or the game participation terminal 160.

As such, a game function may be provided between terminals of friends installing the specific app such as the electronic wallet app.

Further, as such, after the total purchase amount for each coupon to be purchased in the terminals participating in the game is notified to each terminal, the terminal as the game loser pays the total purchase amount according to the game result and may issue a coupon desired by each terminal by interlocking with the coupon server and the service providing device after payment.

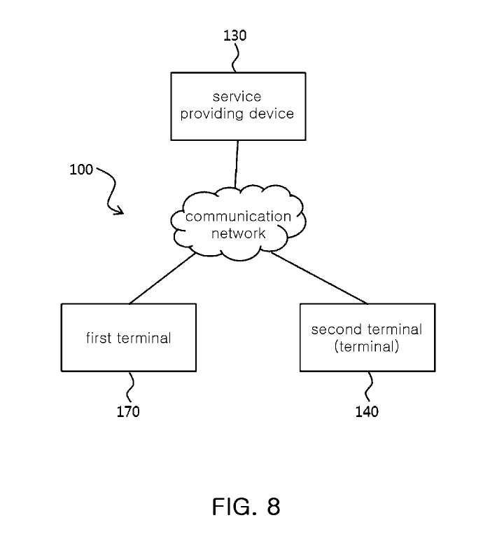

FIG. 8 is a block diagram illustrating a configuration of an electronic wallet system 100 according to yet another embodiment of the present invention.

As illustrated in FIG. 8, the electronic wallet system 100 is constituted by a first terminal 170, a service providing device 130, and a second terminal (alternatively, a terminal) 140. All of the constituent elements of the electronic wallet system 100 illustrated in FIG. 8 are not essential constituent elements, and the electronic wallet system 100 may be implemented by more constituent elements than the constituent elements illustrated in FIG. 8 or less constituent elements therethan.

The first terminal 170 directly generates a coupon and registers the generated coupon in the service providing device 130 or an SNS account together with position information of the first terminal 170 via the communication network. Thereafter, when the second terminal 140 gets the registered coupon from the first terminal 170 registered in the service providing device 130 or the SNS account via the communication network, the second terminal 140 performs a friend setting function with the first terminal 170. Thereafter, when another terminal set as a friend in a predetermined POI to be set in the first terminal 170 or the second terminal 140 is positioned or a new coupon corresponding to the corresponding area is registered, the first terminal 170 or the second terminal 140 transmits the coupon to another terminal set as the friend via the communication network. Further, when the new coupon is registered in the service providing device 130 or the SNS account, the first terminal 170 or the second terminal 140 set as the friend transmits the newly registered coupon to another terminal set as the friend via the communication network.

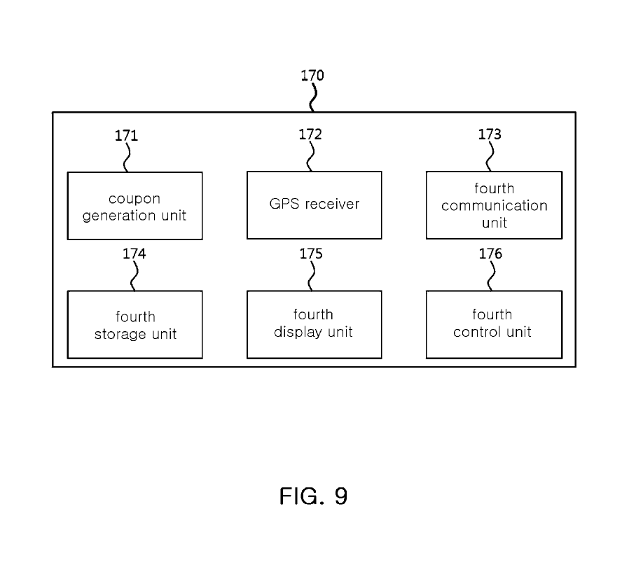

As illustrated in FIG. 9, the first terminal 170 is constituted by a coupon generation unit 171, a GPS receiver 172, a fourth communication unit 173, a fourth storage unit 174, a fourth display unit 175, and a fourth control unit 176. All the constituent elements of the first terminal 170 illustrated in FIG. 9 are not essential constituent elements, and the first terminal 170 may be implemented by more constituent elements than the constituent elements illustrated in FIG. 9 or less constituent elements therethan.

When a predetermined menu (alternatively, function) is selected on an execution result screen according to execution of a specific app such as an electronic wallet app, the coupon generation unit 171 generates the same new coupon as the corresponding coupon based on an on/off type coupon positioned around the first terminal 170. Here, the generated coupon includes coupon information on an affiliated company name, a coupon name, a coupon number, a benefit, a usage place, a usage period, a usage method, and the like.

That is, when the predetermined menu is selected, the coupon generation unit 171 recognizes (alternatively, parses) the coupon positioned around the first terminal 170 photographed by a camera (not illustrated) and generates the same coupon as the corresponding coupon based on the recognized coupon. In this case, the coupon generation unit 171 may dispose information (for example, including an affiliated company name, a coupon name, a coupon number, a benefit, a usage place, a usage period, a usage method, and the like) included in the recognized coupon in a predetermined coupon frame to generate a new coupon.

Further, when the predetermined menu is selected, the coupon generation unit 171 recognizes the coupon positioned around the first terminal 170 through a reader (not illustrated) and may also generate the same coupon as the corresponding coupon based on the recognized coupon.

The GPS receiver 172 receives a GPS signal transmitted from a satellite and generates position data (alternatively, position information) of the first terminal 170 based on a longitude coordinate and a latitude coordinate included in the received GPS signal in real time. Here, the generated position data is defined as a current position (alternatively, current position data/current position information) of the first terminal 170.

In this case, the first terminal 170 may verify the current position of the first terminal 170 through one or more beacons installed around the first terminal 170. The fourth communication unit 173 communicates with an internal constituent element or at least one external terminal via the wired/wireless communication network. In this case, the external terminal may include the service providing device 130, the second terminal 140, an SNS server (not illustrated), and the like.

Further, the fourth communication unit 173 receives contents such as payment-related card information, coupon-related information, gift card-related information, and event information which are transmitted from the service providing device 130 by a control of the fourth control unit 176.

The fourth storage unit 174 stores a user interface (UI), a graphic user interface (GUI), and the like.

Further, the fourth storage unit 174 stores data, programs, and the like required to operate the first terminal 170.

Further, the fourth storage unit 174 stores the contents such as the payment-related card information, the coupon-related information, the gift card-related information, and the event information which are transmitted from the service providing device 130 by a control of the fourth control unit 176.

Further, the fourth storage unit 174 stores a coupon generated through the coupon generation unit 171 by the control of the fourth control unit 176.

The fourth display unit 175 may display contents such as a menu screen by using the UI and the GUI stored in the fourth storage unit 174 by the control of the fourth control unit 176. Here, the contents displayed on the fourth display unit 175 include a menu screen including texts or image data (including various information data) and data such as icons, a list menu, and a combo box, and the like. Further, the fourth display unit 175 may be a touch screen.

Further, the fourth display unit 175 displays the contents such as the payment-related card information, the coupon-related information, the gift card-related information, and the event information through the preinstalled specific app such as the electronic wallet app by the control of the fourth control unit 176.

Further, the fourth display unit 175 displays the coupon generated through the coupon generation unit 171 by the control of the fourth control unit 176 and the position information of the first terminal 170 verified through the GPS receiver 172.

The fourth control unit 176 executes an overall control function of the first terminal 170.

Further, when a specific app such as an electronic wallet or digital wallet app pre-installed in the fourth storage unit 174 is executed, the fourth control unit 176 displays a specific app execution result screen corresponding to the specific app on the fourth display unit 175. Here, the specific app execution result screen includes a my-wallet menu, an add menu, an event/news menu, a more-view menu, and the like. In this case, the more-view menu includes an activity-point menu, a housekeeping book menu, a point integrated inquiry menu, a social network service (SNS)-related menu, and the like. In this case, the my-wallet menu is a menu storing information on the payment-related card, the coupon, the ticket, the gift card, and the like, which are installed or registered in the first terminal 170 through the specific app. Further, the add menu is a menu for newly getting the payment-related card, the coupon, the ticket, other classification items through the specific app. Further, the event/news menu is a menu for verifying information on events or notices and the like transmitted from the service providing device and the like. Further, the activity-point menu is a menu for providing activity points interlocking with a plurality of predetermined apps and a plurality of apps or related companies which may use related activity points. Further, the housekeeping book menu is a menu (alternatively, a housekeeping book-dedicated app) for providing information on details of usage of the card registered in a membership item of the my-wallet menu, details of point usage, and the like in a housekeeping book form. Further, the point integrated inquiry menu is a menu representing point information on the card registered in the membership item of the my-wallet menu. Further, the SNS-related menu is a facebook site-related menu interlocking with the specific app.

Further, when the specific app is executed, the fourth control unit 176 identifies the first terminal 170 through unique identification information such as the MDN, the mobile IP, the mobile MAC, the Sim card unique information, and a serial number and communicates with the service providing device 130 via the wired or wireless communication network. In this case, the fourth control unit 176 transmits the identification information of the first terminal 170 to the service providing device 130 in a background state, and the service providing device 130 identifies the first terminal 170 based on the identification information and communicates with the first terminal 170.

Further, the execution result screen displayed on the fourth display unit 175 includes the contents such as the payment-related card information, the coupon-related information, the gift card-related information, and the event information corresponding to the specific app, and the corresponding contents may include the unique identification information of the first terminal 170 and the like. In this case, the payment-related card information may include an image or a video for the card, an affiliated company name, a card name, a card number, an expiration date, a benefit, an annual fee, barcode information/QR code information/NFC tag information/smart tag information associated with the corresponding card, and the like. Further, the coupon-related information includes an affiliated company name, a coupon name, a coupon number, a benefit, a usage place, a usage period, a usage method, and the like. Further, the gift card-related information includes an affiliated company name, a gift card name, a gift card number, a sum of money, a usage place, a usage period, a usage method, and the like. Further, the identification information of the first terminal 170 includes an MDN, a mobile IP, a mobile MAC, Sim card unique information, a serial number, and the like of the first terminal 170.

Further, when a predetermined specific menu (alternatively, function) is selected on the execution result screen displayed on the fourth display unit 175, the coupon generation unit 171 generates the same coupon as the corresponding coupon based on the coupon positioned around the first terminal 170 by a control of the fourth control unit 176.

Further, the fourth control unit 176 transmits the coupon generated through the coupon generation unit 171 and position information of the first terminal 170 generated (alternatively, verified) through the GPS receiver 172 to the service providing device 130 through the fourth communication unit 173.

That is, the fourth control unit 176 transmits the coupon generated through the coupon generation unit 171 and the position information of the first terminal 170 generated through the GPS receiver 172 to the service providing device 130 through an information transmission menu preset in the specific app.

Further, the fourth control unit 176 receives information on an address which may get the corresponding coupon registered in the service providing device 130 transmitted from the service providing device 130 in response to the transmitted coupon information and the position information of the first terminal 170.

Further, the fourth control unit 176 accesses to the predetermined SNS server corresponding to the first terminal 170 through the fourth communication unit 173 or accesses to the SNS server through an SNS-related menu interlocking with the corresponding specific app.

Further, the fourth control unit 176 links (alternatively, uploads) the coupon information corresponding to the generated coupon or the position information of the first terminal 170 to the corresponding SNS account (alternatively, the SNS account corresponding to a user of the first terminal 170). In this case, the link function for the coupon information and the position information of the first terminal 170 to the SNS account corresponding to the first terminal 170 may be performed by the fourth control unit 176 and the service providing device 130. Further, the coupon information to the SNS account corresponding to the corresponding first terminal 170 includes information such as an affiliated company name, a coupon name, a coupon number, a benefit, a usage place, a usage period, and a usage method and address information of the service providing device 130 which may get the coupon corresponding to the coupon information.

Further, when the coupon generated in the first terminal 170 registered in the service providing device 130 or the SNS server is issued to another terminal (for example, including the second terminal 140 and the like), the fourth control unit 176 receives a terminal (for example, including the second terminal 140 and the like) getting the corresponding coupon transmitted from the service providing device 130 and a user interface for setting a friend (alternatively, setting a relation) with the first terminal 170 through the fourth communication unit 170.

Further, the fourth control unit 176 performs a friend setting function with the terminal (for example, including the second terminal 140 and the like) getting the corresponding coupon and the first terminal 170 through received user interface.

Further, the fourth control unit 176 registers one or more specific POIs for an area of interest of the user of the first terminal 170 in the service providing device 130. In this case, the fourth control unit 176 registers one or more coupons corresponding to the specific POIs in the service providing device 130 together with the corresponding specific POIs.

Further, when the POI information corresponding to the new coupon registered in the service providing device 130 by any one terminal set as the friend with the first terminal 170 among the plurality of terminals corresponds to (alternatively, coincides/interlocks with) the specific POI set by the first terminal 170, the fourth control unit 176 receives a new coupon newly registered in the service providing device 130 by any one terminal issued from the service providing device 130 through the fourth communication unit 173 and registers the received new coupon in the specific app.

Further, the fourth control unit 176 receives the coupon transmitted from one or more terminals (for example, including the second terminal 140 and the like) set as the friend (alternatively, set as the relation) through the fourth communication unit 173 and registers (alternatively, stores) the received coupon in the specific app or the fourth storage unit 174.

Further, the fourth control unit 176 transmits the newly generated coupon to one or more other terminals (for example, including the second terminal 140 and the like) set as the friend through the fourth communication unit 173.

The second communication unit 131 communicates with an internal constituent element or at least one external terminal via the wired/wireless communication network. In this case, the external terminal may include the first terminal 170, the second terminal 140, and the like.

Further, the second communication unit 131 transmits contents such as payment-related card information, coupon-related information, gift card-related information, and event information to the first terminal 170 or the second terminal 140 by a control of the second control unit 134.

Further, the second communication unit 131 receives the coupon transmitted from the first terminal 170 and the position information of the first terminal 170 representing the position where the corresponding coupon is generated by the control of the second control unit 134.

The second storage unit 132 stores a plurality of contents and event information corresponding to each content.

Further, the second storage unit 132 stores the coupon directly generated in the terminal and the position information generating the corresponding coupon (alternatively, the position information of the terminal generating the corresponding coupon) by the control of the second control unit 134.

The second control unit 134 transmits contents such as payment-related card information, coupon-related information, gift card-related information, and event information to the first terminal 170 or the second terminal 140 through the second communication unit 131.

Further, the second control unit 134 issues the payment-related card or the coupon to the first terminal 170 or the second terminal 140 by interlocking with a coupon server (not illustrated) or an affiliated company server (not illustrated). Here, the payment-related card includes a credit card, a check card, a point card, and the like in addition to a membership card. Here, the coupon may be a barcode type, a QR code type, a smart tag type, an NFC tag type, or the like.

Further, the second control unit 134 stores the coupon transmitted from the first terminal 170 received through the second communication unit 131 and the position information of the first terminal 170 in the second storage unit 132.

Further, the second control unit 134 transmits information (alternatively, coupon information) on the coupon transmitted from the first terminal 170 received through the second communication unit 131 and the position information of the first terminal 170 to the terminal (for example, including the second terminal 140 and the like) requesting the information on the plurality of coupons (alternatively, a coupon list including the information on the plurality of coupons) together with other coupons provided from the coupon server through the second communication unit 131.

Further, the second control unit 134 transmits the information on the address which may get the coupon transmitted from the first terminal 170 to the first terminal 170 through the second communication unit 131.

Further, the second control unit 134 links the coupon information transmitted from the first terminal 170 received and the position information of the first terminal 170 to the SNS account corresponding to the first terminal 170 by interlocking with the first terminal 170.

Further, with respect to the second terminal 140 accessing to the service providing device 130 by selecting (alternatively, clicking) the coupon information linked to the account of the first terminal 170 provided from the SNS server, the second control unit 134 verifies the coupon information corresponding to the address information and issues (alternatively, transmits) the coupon corresponding to the verified coupon information (for example, the coupon transmitted/registered to the service providing device 130 from the first terminal 170) to the second terminal 140 through the second communication unit 131.

In this case, when a predetermined specific app is not installed in the second terminal 140, the second control unit 134 installs the corresponding specific app on the second terminal 140 by interlocking with the second terminal 140 and issues the corresponding coupon in the specific app of the second terminal 140 through the second communication unit 131 after the predetermined specific app is installed in the second terminal 140.

Further, when the second terminal 140 gets the coupon registered in the service providing device 130 by the first terminal 170, the second control unit 134 transmits a user interface (UI) for setting a friend (alternatively, setting a relation) between the first terminal 170 and the second terminal 140 to the first terminal 170 and the second terminal 140 through the second communication unit 131, respectively.

Further, in the case of replying a positive response in both the first terminal 170 and the second terminal 140 through the UI for the transmitting friend setting, the second control unit 134 completes the friend setting (alternatively, the relation setting) between the first terminal 170 and the second terminal 140 and stores the friend setting information (for example, the friend setting between the first terminal 170 and the second terminal 140) in the second storage unit 132.

Further, when an event occurs, such as a case where the other terminal is positioned in an area registered (alternatively, set) as the specific POI in any one terminal among the terminals set as the friend, a case where the other terminal registers (alternatively, shares) a coupon interlocking with the corresponding specific POI in response to the area registered as the specific POI in any one terminal among the terminals set as the friend, and a case where a new coupon is registered in any one terminal among the terminals set as the friend, the second control unit 134 automatically transmits (alternatively, issues) the newly registered or the predetermined coupon to the terminals set as the friend in a push message form through the second communication unit 131.

That is, in a state where the specific area is set as the POI in the first terminal 170 among the plurality of terminals set as the friend, when the second terminal 140 which is any one of the plurality of terminals set as the friend is positioned in the corresponding specific area, the second control unit 134 issues the coupon registered by the first terminal 170 in response to the specific area to the second terminal 140 through the second communication unit 131.

Further, in a state where the specific area is set as the POI in the first terminal 170 among the plurality of terminals set as the friend, when position information of the second terminal 140 corresponding to the coupon newly registered by the second terminal 140 which is any one of the plurality of terminals set as the friend is positioned (alternatively, included) in the POI of the corresponding specific area, the second control unit 134 issues the coupon newly registered by the second terminal 140 to the first terminal 170 through the second communication unit 131.

Further, when the first terminal 170 among the plurality of terminals set as the friend registers the new coupon in the service providing device 130 (alternatively, the SNS server), the second control unit 134 issues the coupon newly registered from the first terminal 170 to the rest of the terminals (for example, including the second terminal 140 and the like) except for the first terminal 170 among the plurality of terminals set as the friend through the second communication unit 131, respectively.

In the embodiment of the present invention, the friend setting function between the first terminal 170 and the second terminal 140, the issuance function for the new coupon between the terminals 170 and 140 set as the friend, and the like are performed in the service providing device 130, but are not limited thereto, and the corresponding functions may also be performed by the SNS server.

The third communication unit 141 communicates with an internal constituent element or at least one external terminal via the wired/wireless communication network. In this case, the external terminal may include the first terminal 170, the service providing device 130, the SNS server, and the like.

Further, the third communication unit 141 accesses to the SNS server corresponding to the first terminal 170 by the control of the third control unit 144.

The third display unit 143 displays the coupon information linked with the first terminal 170 provided from the SNS server corresponding to the accessed first terminal 170 and the position information of the first terminal 170 by the control of the third control unit 144.

The third control unit 144 accesses to the SNS server corresponding to the first terminal 170 or the service providing device 130 through the third communication unit 141.

Further, the third control unit 144 displays the coupon information provided from the SNS account of the first terminal 170 of the corresponding SNS server or the service providing device 130 and the position information of the first terminal 170 on the third display unit 143. In this case, the coupon information displayed on the third display unit 143, address information of the service providing device 130 which may get the coupon corresponding to the corresponding coupon information may be included.

Further, when the coupon information displayed on the third display unit 143 is selected (alternatively, clicked), the third control unit 144 accesses to the address information of the service providing device 130 included in the corresponding coupon information.

Further, the third control unit 144 receives the coupon corresponding to the coupon information of the corresponding address information transmitted from the service providing device 130 through the third communication unit 141 and stores the received coupon in the third storage unit 142 or displays the received coupon on the third display unit 143. In this case, when a specific app such as an electronic wallet app is installed in the third control unit 144, a coupon issued from the service providing device 130 through the corresponding specific app may be stored. Further, when the corresponding specific app is not installed in the second terminal 140, the corresponding coupon issued from the service providing device 130 may also be registered in the specific app after the corresponding specific app is installed in the second terminal 140 by interlocking with the service providing device 130.

Further, in the first terminal 170, when the coupon registered in the service providing device 130 or the SNS server is issued from the third control unit 144, the third control unit 144 receives an UI for setting a friend with the first terminal 170 and the second terminal 140 registering the corresponding coupon transmitted from the service providing device 130 in the service providing device 130 or the SNS server through the third communication unit 141.

Further, the third control unit 144 performs a friend setting function with the first terminal 170 and the second terminal 140 generating and registering the corresponding coupon through received UI.

Further, the third control unit 144 registers one or more specific POIs for an area of interest of the user of the second terminal 140 in the service providing device 130.

Further, in the first terminal 170 set as the friend with the second terminal 140, when the specific area is set as the POI, the third control unit 144 verifies the position of the second terminal 140. In addition, when the verified position information of the second terminal 140 is positioned in the specific POI set by the first terminal 170, the third control unit 144 receives a coupon corresponding to the specific POI registered by the first terminal 170 provided from the service providing device 130 and registers the received coupon in the specific app.

Further, in the first terminal 170 set as the friend with the second terminal 140, when the new coupon is registered in the service providing device 130 (alternatively, the SNS server), the third control unit 144 receives a coupon newly registered by the first terminal 170 provided from the service providing device 130 and registers the received coupon in the specific app.

Further, the third control unit 144 transmits the newly generated coupon to one or more other terminals (for example, including the first terminal 170 and the like) set as the friend through the third communication unit 141.

As such, the first terminal directly generates the coupon and may provide the generated coupon to the second terminal through the service providing device.

Further, as such, the first terminal generates the coupon based on the coupon positioned around the first terminal, transmits the generated coupon and the position information of the first terminal to the service providing device, and may provide the transmitted coupon and the position information of the first terminal to the second terminal.

Further, as such, the friend setting between the second terminal getting the coupon generated in the first terminal and the corresponding first terminal is performed, and thereafter, when the new coupon is generated in the first terminal or the second terminal, the newly generated coupon may be shared (alternatively, issued) therebetween.

Hereinafter, a control method of the electronic wallet system according to the present invention will be described in detail with reference to FIGS. 1 to 14.

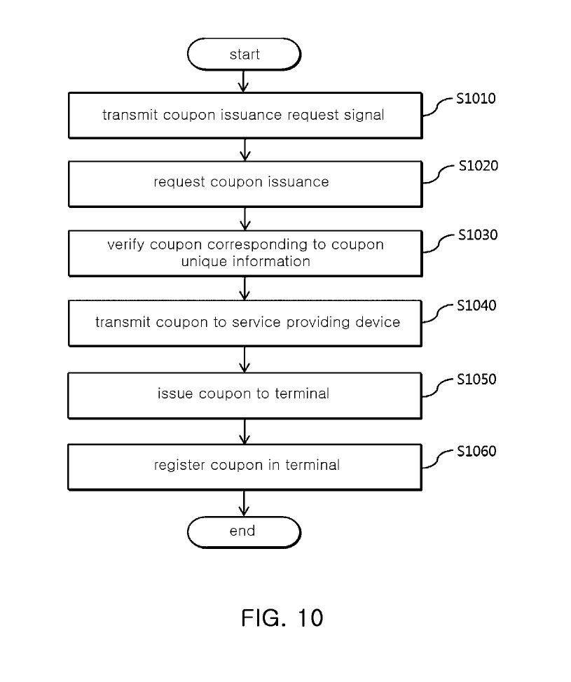

FIG. 10 is a signal flowchart illustrating a communicating process of an electronic wallet system according to a first embodiment of the present invention.

Further, the terminal 140 transmits a coupon issuance request signal to the service providing device 130. Here, the coupon issuance request signal includes coupon information, the identification information of the terminal 140, and the like. In this case, the coupon information includes information on an affiliated company name, a coupon type, a coupon name, a benefit, a usage place, a usage period, a usage method, and the like. In this case, the identification information of the terminal 140 includes an MDN, a mobile IP, a mobile MAC, Sim card unique information, a serial number, and the like of the terminal 140.

As an example, when the specific app such as an electronic wallet app installed in the terminal 140 is executed, the terminal 140 displays an execution result screen. Here, the specific app execution result screen includes a my-wallet menu, an add menu, an event/news menu, a more-view menu, and the like. Thereafter, when a specific coupon is selected on the displayed execution result screen, the terminal 140 generates a coupon issuance request signal including information on the selected specific coupon, the identification information of the terminal 140, and the like and transmits the generated coupon issuance request signal to the service providing device 130 to request the issuance of the corresponding specific coupon (S1010).

Thereafter, the service providing device 130 receives the coupon issuance request signal transmitted from the terminal 140.

Further, the service providing device 130 transmits coupon unique information (for example, a coupon ID) corresponding to the coupon information included in the received coupon issuance request signal and the identification information of the terminal 140 to the coupon server 120 to request the issuance of the corresponding coupon.

As an example, the service providing device 130 receives the coupon issuance request signal including the information on the specific coupon, the identification information of the terminal 140, and the like. Thereafter, the service providing device 130 transmits a coupon ID corresponding to the specific coupon (for example, ‘K’ corresponding to a kimchi coupon) and the identification information of the terminal 140 to the coupon server 120 to request the issuance of the corresponding kimchi coupon (S1020).

Thereafter, the coupon server 120 receives coupon unique information transmitted from the service providing device 130 and the identification information of the terminal 140.

Further, the coupon server 120 verifies a coupon corresponding to the received coupon unique information among a plurality of pre-registered coupons and coupon unique information corresponding to the coupon. Here, the corresponding coupon corresponding to the coupon unique information is a coupon registered in the coupon server 120 in a non-affiliated company which does not interlock with (is not registered in) the coupon server 120 or the service providing device 130, and when the corresponding coupon is registered in the coupon server 120 in the non-affiliated company, after setting the issuance number of the corresponding coupon, the coupon server 120 stores the set information (for example, including the issuance number, a coupon number corresponding to the issuance number, and the like). In this case, when the number of issuable coupons for the corresponding coupon remains, the coupon server 120 verifies (alternatively, selects) any one coupon number among unique coupon numbers corresponding to the issuable coupons.

As an example, the coupon server 120 verifies the corresponding kimchi coupon corresponding to the received coupon unique information among the coupons registered in the coupon server 120 in the non-affiliated store. Thereafter, the coupon server 120 verifies any one coupon number (for example, coupon number=1) among a plurality of issuable (alternatively, usable) coupon numbers corresponding to the verified kimchi coupon (S1030).

Thereafter, the coupon server 120 issues (alternatively, transmits) a corresponding coupon corresponding to the verified coupon number to the service providing device 130.

Further, the coupon server 120 matches the identification information of the terminal 140 with a coupon number corresponding to the verified corresponding coupon and stores the coupon number corresponding to the coupon and the identification information of the terminal 140 which are matched with each other.

As an example, the coupon server 120 issues the corresponding kimchi coupon corresponding to the coupon number (for example, coupon number=1) to the service providing device 130 (S1040).

Thereafter, the service providing device 130 receives the coupon including the coupon number which is issued from the coupon server 120.

Further, the service providing device 130 transmits the received coupon to the terminal 140 to issue the corresponding coupon to the terminal 140.

Further, the service providing device 130 matches the coupon number included in the received coupon with the corresponding coupon unique information and the identification information of the terminal 140 and stores the matched information.

As an example, the service providing device 130 transmits the kimchi coupon including the coupon number transmitted from the coupon server 120 to the terminal 140 to issue the corresponding kimchi coupon to the terminal 140. Further, the service providing device 130 matches the unique information of the corresponding kimchi coupon and the identification information of the terminal 140 with the received coupon number and stores the coupon number, the unique information of the kimchi coupon, and the identification information of the terminal 140 which are matched with each other (S1050).

Thereafter, the terminal 140 registers (alternatively, stores) the corresponding coupon issued from the service providing device 130 in response to the transmitted coupon issuance request signal. In this case, the terminal 140 registers the coupon number for the corresponding coupon together.

As an example, the terminal 140 registers the kimchi coupon including the unique coupon number which is issued from the service providing device 130 (S1060).

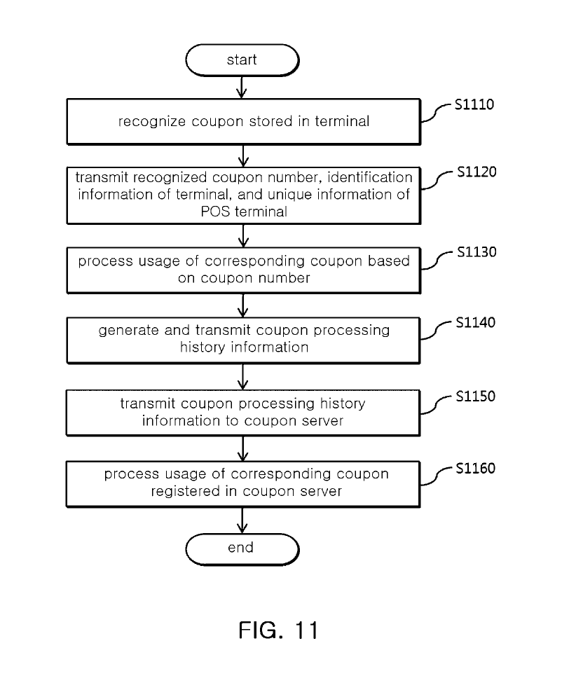

FIG. 11 is a signal flowchart illustrating a communicating process of an electronic wallet system according to a second embodiment of the present invention.

First, when using the coupon stored in the terminal 140, the POS terminal 150 recognizes the coupon stored in the terminal 140 through a reader (not illustrated) included in the POS terminal 150. Here, the coupon may be a barcode type, a QR code type, a smart tag type, an NFC tag type, or the like. Further, the corresponding coupon, as a coupon registered in the coupon server 120 in a non-affiliated company without interlocking with the coupon server 120 or the service providing device 130, may be a coupon issued in the corresponding terminal 140 by the issuance request of the terminal 140 after setting the issuance number of the corresponding coupon in the coupon server and storing the set information (for example, including the issuance number, a coupon number corresponding to the issuance number, and the like) when the non-affiliated company registers the corresponding coupon in the coupon server 120. Further, the reader may be a barcode reader, a QR code reader, a smart tag reader, an NFC reader, and the like for recognizing different types (for example, a barcode type, a QR code type, a smart tag type, an NFC tag type, and the like) of coupons. In this case, when the coupon stored in the terminal 140 is recognized by the POS terminal 150, the POS terminal 150 may communicate with the terminal 140 via the wired or wireless communication network in a background state. Further, the terminal 140 transmits the identification information of the terminal 140 to the POS terminal 150. Here, the identification information includes an MDN, a mobile IP, a mobile MAC, Sim card unique information, a serial number, and the like of the terminal 140.

As an example, the POS terminal 150 recognizes a barcode type kimchi coupon registered in the non-affiliated company stored in the terminal 140 through the reader. Further, the POS terminal 150 communicates with the terminal 140 in the background state and verifies the identification information of the terminal 140 (S1110). Thereafter, the POS terminal 150 transmits a coupon number of the recognized coupon, the received identification information of the terminal 140, unique information of the POS terminal 150, and the like to the affiliated company server 110. Here, the affiliated company server 110 may be a non-affiliated company server issuing the corresponding coupon.

As an example, the POS terminal 150 transmits the coupon number (for example, coupon number=1) of the recognized kimchi coupon, the identification information of the terminal 140, the unique information of the POS terminal 150, and the like to the affiliated company server 110 which is the non-affiliated company issuing the corresponding kimchi coupon (S1120).

Thereafter, the affiliated company server 110 receives the coupon number of the recognized coupon, the received identification information of terminal 140, the unique information of the POS terminal 150, and the like which are transmitted from the POS terminal 150.

Further, the affiliated company server 110 processes the usage of the corresponding coupon based on the coupon number of the received coupon.

That is, the affiliated company server 110 processes the usage of the corresponding coupon by performing the payment function for the corresponding coupon corresponding to the received coupon number.

As an example, the affiliated company server 110 verifies the coupon number (for example, coupon number=1) of the corresponding kimchi coupon and the identification information of the terminal 140 in the coupon numbers corresponding to the plurality of prestored kimchi coupons and the identification information of the terminal 140, and processes the usage of the kimchi coupon (alternatively, the corresponding coupon number) corresponding to the verified coupon number (for example, coupon number=1) (S1130).

Thereafter, the affiliated company server 110 generates coupon processing history information of the used coupon. Here, the coupon processing history information includes payment information (for example, including an amount of payment and the like), coupon unique information corresponding to the coupon number (for example, a coupon ID), identification information of the terminal 140, unique information of the POS terminal 150, and the like.

Further, the affiliated company server 110 transmits the generated coupon processing history information to the service providing device 130.

As an example, the affiliated company server 110 generates the coupon processing history information including the payment information of the used kimchi coupon, the coupon unique information (for example, ‘K’ corresponding to the kimchi coupon) corresponding to the coupon number (for example, coupon number=1), the identification information of the terminal 140, the unique information of the POS terminal 150, and the like and transmits the generated coupon processing history information to the service providing device 130 (S1140).

Thereafter, the service providing device 130 receives the coupon processing history information transmitted from the affiliated company server 110.

Further, the service providing device 130 notifies to the coupon server 120 that the terminal 140 corresponding to the identification information of the terminal 140 included in the coupon processing history information uses the coupon corresponding to the used coupon number by transmitting the received coupon processing history information to the coupon server 120 (S1150).

Thereafter, the coupon server 120 receives the coupon processing history information transmitted from the service providing device 130.

Further, the coupon server 120 processes the corresponding coupon to be used based on the received coupon processing history information.

That is, the coupon server 120 verifies the identification information of the terminal 140 included in the received coupon processing history information in the coupon numbers corresponding to the plurality of prestored coupons and the identification information of the terminal 140 and processes the coupon number corresponding to the verified identification information of the terminal 140 and the corresponding coupon to be used.

As an example, the coupon server 120 verifies the identification information of the terminal 140 included in the received coupon processing history information in the coupon numbers corresponding to the plurality of prestored coupons and the identification information of the terminal 140 and processes the kimchi coupon corresponding to the verified identification information of the terminal 140 and the coupon number (for example, coupon number=1) of the corresponding kimchi coupon to be used.

Further, the coupon server 120 synchronizes the usage processing for the coupon numbers corresponding to the coupons stored in the coupon server 120, the service providing device 130, and the terminal 140 by interlocking with the service providing device 130 and the terminal 140 (S1160).

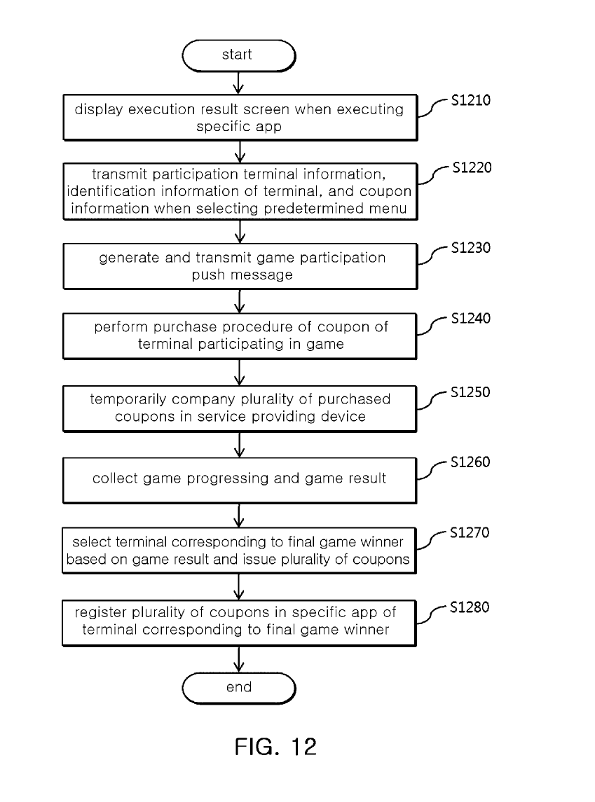

FIG. 12 is a signal flowchart illustrating a communicating process of an electronic wallet system according to a third embodiment of the present invention. First, when a specific app such as an electronic wallet app installed in the terminal 140 is executed, the terminal 140 displays an execution result screen on the third display unit 143 and communicates with the service providing device 130 via the wired or wireless communication network in a background state. In this case, the terminal 140 transmits identification information of the terminal 140 to the service providing device 130. Here, the identification information includes an MDN, a mobile IP, a mobile MAC, Sim card unique information, a serial number, and the like of the terminal 140 (S1210).

Thereafter, when a predetermined all-at-once service (alternatively, a predetermined function/menu) is selected on the execution result screen displayed in the terminal 140, the terminal 140 transmits participation terminal information (alternatively, identification information of a game participation terminal 160), the identification information of the terminal 140, and coupon information corresponding to a specific coupon to the service providing device 130. Here, the coupon information may include information on one coupon or a plurality of coupons. In this case, the terminal 140 may also transmit information on a game type (for example, including a rock-paper-scissors game, a dice game, a ladder game, and the like) together. Here, the coupon information includes information on an affiliated company title (alternatively, an affiliated company name) issuing a coupon, a coupon name, a unique code (alternatively, a coupon number), a title, a benefit, a usage place, a usage period (alternatively, an expiration date), a usage method, a coupon type (for example, a free coupon or a paid coupon), and the like.

That is, when the predetermined all-at-once service is selected on the execution result screen displayed in the terminal 140, the terminal 140 selects information on one or more participation terminals (alternatively, identification information of the game participation terminals 160) to participate in the game through a telephone directory screen prestored in the terminal 140, selects coupon information to be provided according to the game result, and transmits the selected information on one or more participation terminals, the identification information of the terminal 140, and the selected coupon information to the service providing device 130.

As an example, when the predetermined all-at-once service is selected on the execution result screen displayed in the terminal 140, the terminal 140 selects terminal A, terminal B, and terminal C to participate in the game through the telephone directory screen prestored in the terminal 140, selects coupon information for ‘10% discount coupon in restaurant A’ to be provided according to the game result, and transmits participation terminal information including the identification information of the selected terminal A, terminal B, and terminal C, the identification information of the terminal 140, and the coupon information for the selected ‘10% discount coupon in restaurant A’ to the service providing device 130 (S1220).

Thereafter, the service providing device 130 receives the information on one or more participation terminals, the identification information of the terminal 140, and the coupon information, which are transmitted from the terminal 140.

Further, the service providing device 130 generates a game participation push message including the coupon information. Here, the game participation push message includes information on a game hosted in the terminal 140, coupon information to be provided through the corresponding game, information on the participation terminal to participate in the corresponding game (alternatively, identification information of the game participation terminal 160 to participate in the corresponding game), the identification information of the terminal 140, and the like. In this case, the participation terminal information may include the identification information of the game participation terminal 160 selected in the terminal 140, a name stored in the terminal 140 corresponding to the identification information of the game participation terminal 160, or the like.

Further, the service providing device 130 transmits the generated game participation push message to one or more game participation terminals 160 corresponding to the received information on one or more participation terminals, respectively.

As an example, the service providing device 130 generates a game participation push message including coupon information for the ‘10% discount coupon in restaurant A’ and transmits the generated game participation push message to terminal A, terminal B, and terminal C corresponding to identification information of the terminal A, the terminal B, and the terminal C, respectively (S1230).

Thereafter, each game participation terminal 160 receives the game participation push message including the coupon information transmitted from the service providing device 130.

Further, the game participation terminal 160 displays the received game participation push message.

Further, when the game participation terminal 160 selects the coupon information included in the game participation push message in order to participate in the game, the game participation terminal 160 performs an issuance procedure for the coupon corresponding to the coupon information by interlocking with the service providing device 130 and the coupon server 120.

Further, the terminal 140 hosting the game performs a purchase procedure for the coupon corresponding to the coupon information by interlocking with the service providing device 130 and the coupon server 120.

As an example, when the coupon information included in the game participation push message is selected in each of the terminal A, the terminal B, and the terminal C or a predetermined button is selected, each of the terminal A, the terminal B, and the terminal C transmits a coupon purchase request signal to the service providing device 130. Thereafter, the service providing device 130 transmits the corresponding coupon purchase request signal to the coupon server 120. Thereafter, each of the terminal A, the terminal B, and the terminal C performs a payment function (alternatively, a purchase procedure) for the ‘10% discount coupon in restaurant A’ corresponding to the coupon information for the ‘10% discount coupon in restaurant A’ by interlocking with the service providing device 130 and the coupon server 120 to complete a purchase for the corresponding coupon. Further, the terminal 140 performs the payment function of the ‘10% discount coupon in restaurant A’ to complete the purchase for the corresponding coupon (S1240).

Thereafter, the service providing device 130 gets a plurality of coupons purchased in the terminal 140 and one or more game participation terminals 160 from the coupon server 120 and temporarily stores the plurality of issued coupons.

As an example, the service providing device 130 gets four sheets of ‘10% discount coupons in restaurant A’ purchased from the coupon server 120 in each of the terminal 140, the terminal A, the terminal B, and the terminal C from the coupon server 120 and temporarily stores the issued four sheets of ‘10% discount coupons in restaurant A’(S1250).

Thereafter, when the coupon purchase procedure is completed in the terminals to participate in the game within a predetermined time, the service providing device 130 progresses the game between the terminals participating in the game (for example, including the terminal 140, one or more game participation terminals 160, and the like) and collects the corresponding game result. In this case, the corresponding game may be a game which is randomly selected from a plurality of games prestored in the service providing device 130 or a game corresponding to information on a game type transmitted after being set in the terminal 140.

As an example, when the coupon purchase procedure is completed in the terminal 140, the terminal A, the terminal B, and the terminal C within the predetermined time, the service providing device 130 progresses a predetermined ladder game in the terminal 140, the terminal A, the terminal B, and the terminal C participating in the game and collects the result of the corresponding ladder game (S1260).

Thereafter, the service providing device 130 selects a terminal corresponding to the final game winner based on the collected game result.

That is, the service providing device 130 selects a terminal corresponding to the final game winner among the terminal 140 and one or more game participation terminals 160 participating in the game based on the collected game result.

Further, the service providing device 130 issues the plurality of coupons temporarily stored to the terminal corresponding to the selected final game winner.

Further, the service providing device 130 transmits a coupon issuance completion guidance message notifying that the coupon issuance is completed, to the rest of the terminals except for the terminal corresponding to the final game winner among the terminals participating in the game. Here, the coupon issuance completion guidance message includes information on the final game winner (alternatively, identification information of the terminal corresponding to the final game winner), coupon issuance completion information, and the like.

As an example, the service providing device 130 selects the terminal B as the final game winner based on the collected game result and issues the four sheets of ‘10% discount coupons in restaurant A’ temporarily stored in the terminal B selected as the final game winner. Further, the service providing device 130 transmits the coupon issuance completion guidance message including coupon issuance completion information, information on the terminal B as the final game winner, and the like in the terminal 140, the terminal A, and the terminal C which are the remaining terminals (S1270).

Thereafter, the terminal corresponding to the final game winner registers the coupon issued from the service providing device 130 in the specific app.

Further, the rest of the terminals participating in the game receives the coupon issuance completion guidance message transmitted from the service providing device 130 and outputs the received coupon issuance completion guidance message.

As an example, the terminal B as the final game winner registers the four sheet of ‘10% discount coupons in restaurant A’ issued from the service providing device 130 in the specific app such as the electronic wallet app preinstalled in the terminal B.

Further, the terminal 140, the terminal A, and the terminal C which are the rest of the terminals participating in the game receive the coupon issuance completion guidance message transmitted from the service providing device 130, respectively, and output the received coupon issuance completion guidance message, respectively (S1280).

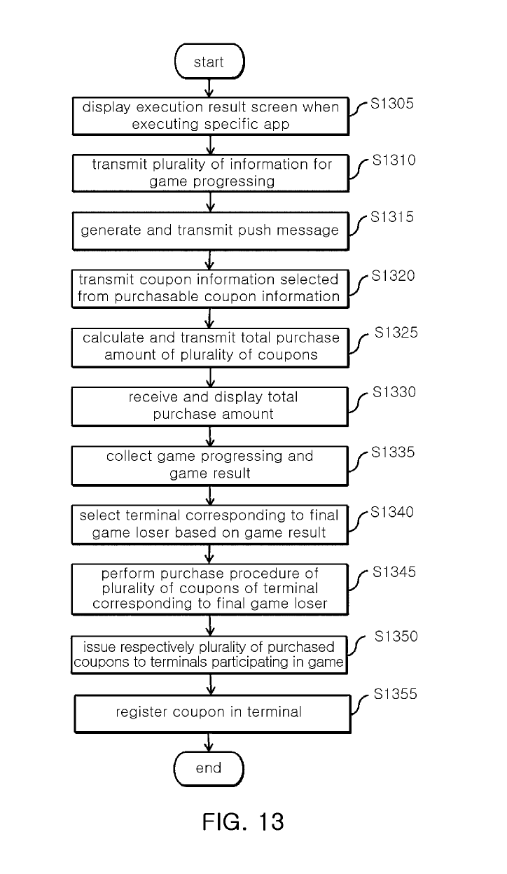

FIG. 13 is a signal flowchart illustrating a communicating process of an electronic wallet system according to a fourth embodiment of the present invention.

First, when a specific app such as an electronic wallet app installed in the terminal 140 is executed, the terminal 140 displays an execution result screen on the third display unit 143 and communicates with the service providing device 130 via the wired or wireless communication network in a background state. In this case, the terminal 140 transmits the identification information of the terminal 140 to the service providing device 130. Here, the identification information includes an MDN, a mobile IP, a mobile MAC, Sim card unique information, a serial number, and the like of the terminal 140.

Thereafter, when a predetermined menu (alternatively, a predetermined function/menu) is selected on the execution result screen displayed in the terminal 140, the terminal 140 transmits to the service providing device 130 a game type (for example, a rock-paper-scissors game, a dice game, a ladder game, and the like), purchasable coupon information, participation terminal information (alternatively, identification information of a game participation terminal 160), and the identification information of the terminal 140. Here, the purchasable coupon information includes information on a plurality of coupons. Further, the coupon information includes information on an affiliated company title (alternatively, an affiliated company name) issuing a coupon, a coupon name, a unique code (alternatively, a coupon number), a title, a benefit, a usage place, a usage period (alternatively, an expiration date), a usage method, a coupon type (for example, a free coupon or a paid coupon), and the like.

That is, when the predetermined menu is selected on the execution result screen displayed in the terminal 140, the terminal 140 selects a game type through the game type information screen prestored in the terminal 140, selects information on a plurality of purchasable coupons which may be provided according to the game result in a coupon list transmitted from the service providing device 130, selects information on one or more participation terminals (alternatively, identification information of the game participation terminal 160) to participate in the game through the telephone directory screen prestored in the terminal 140, and transmits the selected game type, the selected purchasable coupon information, the selected information on the one or more participation terminals, and the identification information of the terminal 140 to the service providing device 130.

As an example, when the predetermined game menu is selected on the execution result screen displayed in the terminal 140, the terminal 140 selects a ladder game which is the game type through the game type information screen prestored in the terminal 140, selects information on three coupons such as purchasable ‘discount coupon in restaurant A’, ‘discount coupon in mart B’, and ‘discount coupon in theatre C’ which may be provided according to the game result in the coupon list transmitted from the service providing device 130, selects the terminal A, the terminal B, and the terminal C to participate in the game through the telephone directory screen prestored in the terminal 140, and transmits the game type including the selected ladder game, the information on three selected purchasable coupons (for example, the ‘discount coupon in restaurant A’, ‘discount coupon in mart B’, and ‘discount coupon in theatre C’), participation terminal information including identification information on the selected terminal A, terminal B, and terminal C, and the identification information of the terminal 140 to the service providing device 130 (S1310).

Thereafter, the service providing device 130 receives the game type, the purchasable coupon information, the information on one or more participation terminals, and the identification information of the terminal 140 which are transmitted from the terminal 140.

Further, the service providing device 130 generates a push message for inducing game participation of the game participation terminal 160 corresponding to the information on one or more participation terminals. Here, the push message includes information on a game hosted in the terminal 140 (alternatively, a game type), information on a purchasable coupon provided according to the corresponding game result, information on a participation terminal to participate in the corresponding game (alternatively, identification information of the game participation terminal 160 to participate in the corresponding game), the identification information of the terminal 140, and the like. In this case, the participation terminal information may include identification information of the game participation terminal 160 selected from the terminal 140, a name stored in the terminal 140 corresponding to the identification information of the game participation terminal 160, or the like.

Further, the service providing device 130 transmits the generated push message to one or more game participation terminals 160 corresponding to the received information on one or more participation terminals, respectively.

As an example, the service providing device 130 generates a push message including the ladder game information, the information on three purchasable coupons (for example, ‘discount coupon in restaurant A’, ‘discount coupon in mart B’, and ‘discount coupon in theatre C’), the participation terminal information including identification information of the terminal A, the terminal B, and the terminal C, the identification information of the terminal 140, and the like and transmits the generated push message to the terminal A, the terminal B, and the terminal C corresponding to the identification information of the terminal A, the terminal B, and the terminal C, respectively (S1315).

Thereafter, each game participation terminal 160 receives the push message including the coupon information transmitted from the service providing device 130.

Further, the game participation terminal 160 displays the received push message.

Further, in the case where each game participation terminal 160 intends to participate in the game, the game participation terminal 160 selects information on one coupon from the information on the purchasable coupons included in the corresponding push message and transmits the selected coupon information to the service providing device 130.

Further, the terminal 140 hosting the game selects the information on one coupon from the information on the purchasable coupons and transmits the selected coupon information to the service providing device 130.

As an example, each of the terminal A, the terminal B, and the terminal C selects information on any one coupon from information on purchasable coupons (for example, ‘discount coupon in restaurant A’, ‘discount coupon in mart B’, and ‘discount coupon in theatre C’) included in the push message (for example, selects the ‘discount coupon in restaurant A’ in the terminal A and the terminal C and selects the ‘discount coupon in theatre C’ in the terminal B), and the terminal 140 selects information on one coupon from information on purchasable coupons (for example, ‘discount coupon in mart B’), information on the coupon selected in each terminal (for example, the ‘discount coupon in restaurant A’ in the terminal A and the terminal C, the ‘discount coupon in theatre C’ in the terminal B, and the ‘discount coupon in mart B’ on the terminal 140) to the service providing device 130 (S1320).

Thereafter, the service providing device 130 receives information on coupons transmitted from the terminal 140 and one or more game participation terminals 160 and temporarily stores the received coupon information, respectively.

Further, when the coupon information transmitted from the terminals to participate in the game is received within a predetermined time, the service providing device 130 computes (alternatively, calculates) a total purchase amount of the plurality of coupons corresponding to the coupon information transmitted respectively from the terminals participating in the game (for example, including the terminal 140, one or more game participation terminals 160, and the like).

That is, the service providing device 130 calculates information on the total purchase amount of coupons to be provided to the respective terminals when participating in the game.

Further, the service providing device 130 transmits the calculated total purchase amount to the terminals (for example, including the terminal 140, one or more game participation terminals 160, and the like) participating in the game, respectively.

As an example, when reception of the coupon information transmitted from each of the terminals to participate in the game is completed within a predetermined time, the service providing device 130 calculates the total purchase amount for the ‘discount coupon in mart B’, the ‘discount coupon in restaurant A’, the ‘discount coupon in theatre C’, and the ‘discount coupon in restaurant A’ which are purchased by the terminal 140, the terminal A, the terminal B, and the terminal C participating in the game, respectively, and transmits the calculated total purchase amount to the terminal 140, the terminal A, the terminal B, and the terminal C participating in the game, respectively (S1325).

Thereafter, the terminals participating in the game receives the total purchase amount transmitted from the service providing device 130 and displays the received total purchase amount.

As an example, each of the terminal 140, the terminal A, the terminal B, and the terminal C participating in the game receives the total purchase amount required when purchasing the coupon according to the game result transmitted from the service providing device 130 and displays the received total purchase amount (S1330).

Thereafter, when it is the predetermined time, the service providing device 130 progresses the game between the terminals participating in the game (for example, including the terminal 140, one or more game participation terminals 160, and the like) and collects the corresponding game result.

As an example, when it is the predetermined time, the service providing device 130 progresses the ladder game with respect to the terminal 140, the terminal A, the terminal B, and the terminal C participating in the game and collects the result of the corresponding ladder game (S1335).

Thereafter, the service providing device 130 selects the terminal corresponding to the final game loser based on the collected game result.

That is, the service providing device 130 selects the terminal corresponding to the final game loser (the last rank) among the terminal 140 and one or more game participation terminals 160 participating in the game based on the collected game result.

As an example, the service providing device 130 selects the terminal C as the final game loser based on the collected game result (S1340).

Thereafter, the service providing device 130 performs the purchase procedure for a coupon to be issued to each terminal participating in the game by interlocking with the selected terminal corresponding to the final game loser and the coupon server 120.

As an example, the service providing device 130 transmits information on a plurality of coupons (for example, the ‘discount coupon in restaurant A’ in the terminal A and the terminal C, the ‘discount coupon in theatre C’ in the terminal B, and the ‘discount coupon in mart B’ on the terminal 140′) to be purchased in each terminal participating in the game which is temporarily stored in terminal C as the selected final game loser. Thereafter, the terminal C transmits a coupon purchase request signal for the plurality of coupons corresponding to the plurality of coupon information to the service providing device 130. Thereafter, the service providing device 130 transmits the coupon purchase request signal for the plurality of coupons to the coupon server 120. Thereafter, the terminal C performs the payment function (alternatively, the purchase procedure) for the plurality of coupons (for example, the ‘discount coupon in restaurant A’ in the terminal A and the terminal C, the ‘discount coupon in theatre C’ in the terminal B, and the ‘discount coupon in mart B’ on the terminal 140) to be purchased in each terminal participating in the game by interlocking with the service providing device 130 and the coupon server 120 to complete the purchase for the corresponding coupon (S1345).

Thereafter, when the purchase procedure for the coupons issued to the terminals participating in the game is completed, the service providing device 130 gets the plurality of coupons purchased in the terminal as the final game loser from the coupon server 120. Here, information on the terminal as the final game loser may be included in each of the plurality of coupons.

Further, the service providing device 130 issues the coupon issued from the coupon server 120 according to the information on the coupon to be purchased by each terminal participating in the game to the corresponding terminals 140 and 160, respectively.

As an example, when the issuance procedure of the plurality of coupons is completed through the terminal C, the service providing device 130 gets two ‘discount coupons in restaurant A’, one ‘discount coupon in theatre C’, and one ‘discount coupon in mart B’ issued from the coupon server 120. Thereafter, the service providing device 130 issues the plurality of coupons issued from the coupon server 120 based on the information on the coupons (for example, the ‘discount coupon in restaurant A’ in the terminal A and the terminal C, the ‘discount coupon in theatre C’ in the terminal B, and the ‘discount coupon in mart B’ in the terminal 140) to be purchased in the terminal 140, the terminal A, the terminal B, and the terminal C participating in the game to the corresponding terminals 140 and 160, respectively. That is, the service providing device 130 issues the ‘discount coupon in mart B’ to the terminal 140, the ‘discount coupon in restaurant A’ to the terminal A, the ‘discount coupon in theatre C’ to the terminal B, and the ‘discount coupon in restaurant A’ to the terminal C, respectively (S1350).

Thereafter, the terminals 140 and 160 participating in the game register the coupons issued from the service providing device 130 in the specific app. Here, the coupon registered in each of the terminals 140 and 160 includes information on the terminal as the final game loser (alternatively, the identification information of the terminal as the final game loser).

Further, when the corresponding coupon registered in the specific app is used, the corresponding terminals 140 and 160 using the coupons or the service providing device 130 transmits a push message including a gratitude greeting message to the terminal as the final game loser purchasing the corresponding coupon.

As an example, the terminal 140 participating in the game registers the ‘discount coupon in mart B’ issued from the service providing device 130 in the specific app of the terminal 140, the terminal A registers the ‘discount coupons in restaurant A’ issued from the service providing device 130 in the specific app of the terminal A, the terminal B registers the ‘discount coupons in theatre C’ issued from the service providing device 130 in the specific app of the terminal B, and the terminal C registers the ‘discount coupons in restaurant A’ issued from the service providing device 130 in the specific app of the terminal C. Thereafter, when the ‘discount coupons in restaurant A’ registered in the terminal A is used, the terminal A or the service providing device 130 transmits the push message including the gratitude greeting message to the corresponding terminal C based on the identification information of the terminal C as the final game loser include in the corresponding coupon (S1355).

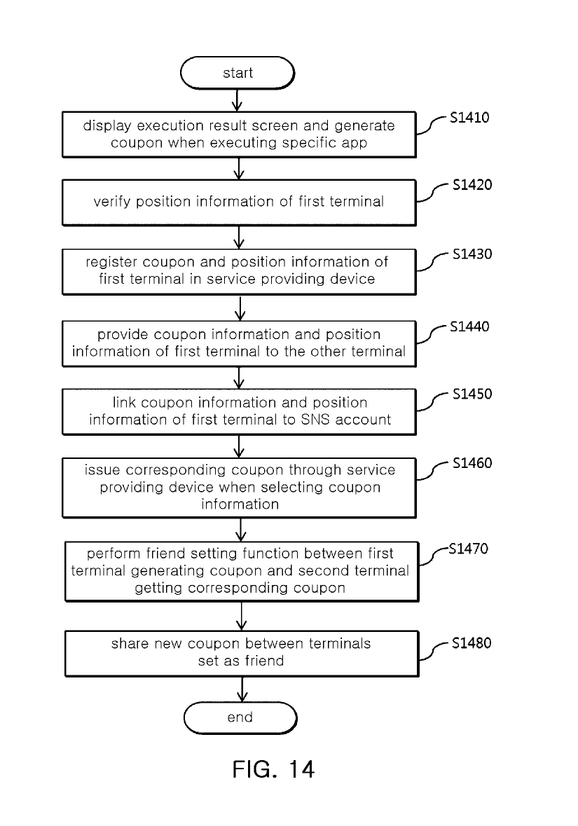

FIG. 14 is a signal flowchart illustrating a communicating process of an electronic wallet system according to a fifth embodiment of the present invention.

First, when a specific app such as an electronic wallet app installed in the first terminal 170 is executed, the first terminal 170 displays an execution result screen on the fourth display unit 175 and may communicate with the service providing device 130 via the wired or wireless communication network in a background state.

Further, when a predetermined specific menu (alternatively, function) is selected on the execution result screen displayed in the first terminal 170, the first terminal 170 generates the same coupon as the corresponding coupon based on the coupon positioned around the first terminal 170. Here, the generated coupon includes coupon information on an affiliated company name, a coupon name, a coupon number, a benefit, a usage place, a usage period, a usage method, and the like.

That is, when a predetermined specific menu (alternatively, function) is selected on the execution result screen displayed in the first terminal 170, the first terminal 170 photographs the coupon positioned around the first terminal 170 through a camera (not illustrated) provided in the first terminal 170 or recognizes the coupon through a reader (not illustrated). Thereafter, the coupon generation unit 171 included in the first terminal 170 recognizes (alternatively, parses) the photographed (alternatively, recognized) coupon and generates the same coupon as the corresponding coupon based on the recognized (alternatively, parsed) coupon. In this case, the coupon generation unit 171 may dispose respectively information (for example, including an affiliated company name, a coupon name, a coupon number, a benefit, a usage place, a usage period, a usage method, and the like) included in the recognized (alternatively, parsed) coupon in a predetermined coupon frame to generate a new coupon.

As an example, when the specific app such as an electronic wallet app preinstalled in the first terminal 170 is executed, the first terminal 170 displays an execution result screen. Here, the specific app execution result screen includes a my-wallet menu, an add menu, an event/news menu, a more-view menu, a coupon generation menu, and the like. Thereafter, when the coupon generation menu as the predetermined specific menu is selected on the execution result screen displayed in the first terminal 170, the first terminal 170 generates an on-line type ‘discount coupon in restaurant A’ based on a paper type ‘discount coupon in restaurant A’ which is an off-line type coupon distributed in an area where the first terminal 170 is positioned.

As another example, when the coupon generation menu as the predetermined specific menu is selected on the execution result screen displayed in the first terminal 170, the first terminal 170 generates an on-line type ‘discount coupon in restaurant A’ based on an NFC type ‘discount coupon in restaurant A’ fixed in the area where the first terminal 170 is positioned (S1410).

Thereafter, the first terminal 170 verifies a current position of the first terminal 170 through the GPS receiver 172 included in the first terminal 170. In this case, the first terminal 170 may verify the current position of the first terminal 170 through one or more beacons installed around the first terminal 170.

As an example, the first terminal 170 receives a GPS signal transmitted from a satellite through the GPS receiver 172 and generates position data (alternatively, position information) (for example, a station D) of the first terminal 170 based on a longitude coordinate and a latitude coordinate included in the received GPS signal in real time (S1420).

Thereafter, the first terminal 170 transmits the generated coupon (alternatively, the generated coupon including the coupon information) and the position information of the first terminal 170 to the service providing device 130.

That is, the first terminal 170 transmits the generated coupon and the position information of the first terminal 170 to the service providing device 130 through an information transmission menu predetermined in the specific app.

As an example, the first terminal 170 transmits the generated ‘discount coupon in restaurant A’ and the station D which is the position information of the first terminal 170 to the service providing device 130 (S1430).

Thereafter, the service providing device 130 receives the coupon and the position information of the first terminal 170 which are transmitted from the first terminal 170.

Further, the service providing device 130 matches the received coupon and the position information of the first terminal 170 and stores the matched information (for example, the coupon and the position information of the first terminal 170).

Further, the service providing device 130 provides coupon information for the coupon generated in the first terminal 170 to other terminals together with the information of the plurality of coupons provided from the coupon server (not illustrated) (S1440).

Thereafter, the first terminal 170 accesses to a predetermined SNS server (not illustrated) corresponding to the first terminal 170 or accesses to the SNS server through an SNS-related menu interlocking with the corresponding specific app.

Further, the first terminal 170 links (alternatively, uploads) coupon information corresponding to the generated coupon (alternatively, the generated coupon) and the position information of the first terminal 170 to the corresponding SNS account.

Further, the link of the coupon information and the position information of the first terminal 170 to the SNS account corresponding to the first terminal 170 may be performed by the first terminal 170 and the service providing device 130.

As an example, the first terminal 170 accesses to the SNS server subscribed by the first terminal 170 through the SNS-related menu interlocking with the specific app and links the coupon information for the generated coupon and the verified position information of the first terminal 170 to the SNS account of the first terminal 170 (S1450).

Thereafter, when another second terminal 140 (alternatively, a user of the second terminal 140) selects (alternatively, clicks) the coupon information linked to the SNS account of the first terminal 170 of the SNS server, the second terminal 140 downloads (alternatively, gets) the coupon corresponding to the coupon information in the second terminal 140 and registers (alternatively, stores) the downloaded coupon in the specific app of the second terminal 140. Further, the second terminal (alternatively, the terminal) 140 displays the registered coupon through the specific app.

In this case, when the specific app is not installed in the second terminal 140, the corresponding specific app is installed in the second terminal 140 by interlocking between the service providing device 130 and the second terminal 140 and may get the corresponding coupon through the specific app after the specific app is installed in the second terminal 140.

As an example, when the second terminal 140 selects (alternatively, clicks) the coupon information linked to the SNS account of the first terminal 170 of the SNS server, the second terminal 140 downloads the coupon corresponding to the coupon information through the specific app of the second terminal 140 and stores (alternatively, registers) the downloaded coupon (S1460).

Thereafter, when the second terminal 140 downloads the coupon provided from the first terminal 170, the SNS server provides a UI for setting a friend (alternatively, setting the relation) between the first terminal 170 and the second terminal 140 to induce the friend setting between the first terminal 170 and the second terminal 140. As a result, the first terminal 170 and the second terminal 140 perform the friend setting therebetween. Further, friend setting information set between the first terminal 170 and the second terminal 140 is transmitted to the service providing device 130.

As an example, when the second terminal 140 downloads the coupon provided from the first terminal 170, the second terminal 140 performs a friend setting function with the first terminal 170 through the UI provided from the SNS server (S1470).

Thereafter, in the case where the other terminal is positioned in the area registered as the specific POI in any one terminal among the terminals set as the friend, in the case where the other terminal registers (alternatively, shares) the coupon interlocking with the specific POI in response to the area registered as the specific POI in any one terminal among the terminals set as the friend, and in the case where a new coupon is registered in any one terminal among the terminals set as the friend, the service providing device 130 (alternatively, the SNS server) transmits the corresponding information (for example, the new coupon) to the terminal set as the friend or the other terminal in a push message form.

As an example, when the second terminal 140 is positioned at the station D while the first terminal 170 sets the station D as the specific POI in the first terminal 170 and the second terminal 140 set as the friend, the service providing device 130 transmits (issues) the coupon registered by the first terminal 170 corresponding to the station D to the second terminal 140 set as the friend.

As another example, when the position information interlocking with the coupon newly registered by the second terminal 140 is the station D while the first terminal 170 sets the station D as the specific POI in the first terminal 170 and the second terminal 140 set as the friend, the service providing device 130 transmits the coupon newly registered by the second terminal 140 to the first terminal 170 set as the friend.

As yet another example, when the first terminal 170 registers the new coupon to the service providing device 130 (alternatively, the SNS server) in the first terminal 170 and the second terminal 140 set as the friend, the service providing device 130 transmits the coupon newly registered by the first terminal 170 to the second terminal 140 set as the friend (S1480).

The control method of the affiliated company server and the coupon server according to the embodiment of the present invention may be prepared with a computer program, and codes and code segments configuring the computer program may easily deduced by a computer programmer in the art. Further, the corresponding computer program is stored in a non-transitory computer readable storage media and read and executed by the computer or the affiliated company server, the coupon server, the service providing device, the terminal, the POS terminal, and the like according to the embodiment of the present invention to implement the control method of the affiliated company server and the coupon server.

The non-transitory computer readable storage media include a magnetic storage medium, an optical storage medium, and a carrier wave medium. The computer program implementing the control method of the affiliated company server and the coupon server according to the embodiment of the present invention may be stored and installed in embedded memories of the affiliated company server, the coupon server, the service providing device, the terminal, the POS terminal, and the like. Alternatively, an external memory such as a smart card storing and installing the computer program implementing the control method of the affiliated company server and the coupon server according to the embodiment of the present invention may be installed on the affiliated company server, the coupon server, the service providing device, the terminal, the POS terminal, and the like through an interface.

According to the embodiment of the present invention, as described above, it is possible to improve convenience of the user and management efficiency by diversity of the coupons provided in the non-affiliated company by issuing the corresponding coupon to the terminal requesting the corresponding coupon through the service providing device and performing the usage for the corresponding coupon by interlocking with the affiliated company server when using the corresponding coupon in the terminal, after the coupon provided in the non-affiliated company is pre-registered in the coupon server.

Further, according to the embodiment of the present invention, as described above, it is possible to expand a coupon interlocking field with the affiliated company and the non-affiliated company by performing the usage for the corresponding coupon by interlocking with the affiliated company server when using the corresponding coupon in the terminal storing the coupon issued in the non-affiliated company.

Further, according to the embodiment of the present invention, as described above, it is possible to arouse a user's interest of the terminal installing the specific app such as the electronic wallet app by providing the game function between the terminals of the friends installing the specific app such as the electronic wallet app.

Further, according to the embodiment of the present invention, as described above, it is possible to diversify provided contents and improve convenience of the user by issuing the plurality of coupons temporarily stored in the service providing device to the terminal of the game winner according to the game result, after the coupons are purchased through the coupon server in the terminals participating in the game to be temporarily stored in the service providing device.

Further, according to the embodiment of the present invention, as described above, it is possible to diversify provided contents and improve convenience of the user by paying the total purchase amount according to the game result in the terminal as the game loser and issuing a coupon desired by each terminal by interlocking with the coupon server and the service providing device after payment, after the total purchase amount for the coupons to be purchased in the terminals participating in the game is notified to each terminal.

Further, according to the embodiment of the present invention, as described above, it is possible to arouse a user's interest of the terminal and improve availability of the coupons by directly generating the coupon in the first terminal and providing the generated coupon to the second terminal through the service providing device.

Further, according to the embodiment of the present invention, as described above, it is possible to enhance real-time usability of the coupons through the coupons based on the position information of the generated coupon and improve convenience of the usage by generating the coupon in the first terminal based on the coupon positioned around the first terminal, transmitting the generated coupon and the position information of the first terminal to the service providing device, and providing the transmitted coupon and the position information of the first terminal to the second terminal.

Further, according to the embodiment of the present invention, as described above, it is possible to enhance usability of the contents by performing the friend setting between the second terminal getting the coupon generated in the first terminal and the corresponding first terminal and thereafter, sharing (alternatively, issuing) the newly generated coupon therebetween when the new coupon is generated in the first terminal or the second terminal.

The present invention may be widely used in a wireless charging system field, an advertisement/public relations field, and the like by performing a charging function based on a charge signal in the corresponding terminal by transmitting the charge signal to only the terminal corresponding to a communication carrier or an affiliated store company pre-registered in a wireless charger to provide a charging function to only the pre-registered terminal with respect to a terminal to use a wireless charging infrastructure, easily and conveniently perform an authentication function for the terminal without a separate additional component, and improve operation efficiency of the entire wireless charging system.

Hereinabove, although the present invention is described by specific matters such as concrete components, and the like, embodiments, and drawings, they are provided only for assisting in the entire understanding of the present invention. Therefore, the present invention is not limited to the embodiments. Various modifications and changes may be made by those skilled in the art to which the present invention pertains from this description.

Therefore, the spirit of the present invention should not be limited to the above-described embodiments, and the following claims as well as all modified equally or equivalently to the claims are intended to fall within the scope and spirit of the invention.

1. An affiliated company server comprising:
a communication unit configured to receive a coupon number of a coupon recognized through a POS terminal transmitted from the POS terminal, identification information of a terminal, and unique information of the POS terminal when using the coupon stored in the terminal;
a storage unit configured to prestoring a plurality of coupons, coupon information corresponding to each coupon, and the identification information of the terminal interlocking with the coupon information; and
a control unit configured to control the communication unit so as to process a usage of the coupon corresponding to the received coupon number, generate coupon processing history information of the used coupon, and transmit the generated coupon processing history information to the service providing device, in the coupon information corresponding to the plurality of prestored coupons and the identification information of the terminal.

2. The affiliated company server of claim 1, wherein the coupon corresponding to the received coupon number is a coupon registered in the coupon server in a non-affiliated company which does not interlock with the coupon server or the service providing device.

3. The affiliated company server of claim 1, wherein the coupon processing history information includes payment information, coupon unique information corresponding to the used coupon number, the identification information of the terminal, and the unique information of the POS terminal.

4. A coupon server comprising:
a communication unit configured to receive coupon processing history information transmitted from an affiliated company server via a service providing device when using a coupon registered in the coupon server in a non-affiliated company which does not interlock with the coupon server or the service providing device;
a storage unit configured to prestoring a plurality of coupons, coupon information corresponding to each coupon, and the identification information of the terminal interlocking with the coupon information; and
a control unit configure to verify identification information of the terminal included in the received coupon processing history information in the prestored information on the plurality of coupons and the identification information of the terminal, process a usage of a coupon number and a coupon corresponding to the verified identification information of the terminal, and perform a usage synchronization function for the used coupon by interlocking with the service providing device and the terminal.

5. The coupon server of claim 4, wherein the coupon includes the coupon number selected from coupon numbers corresponding to issuable coupons pre-registered in the coupon server.

6. (canceled)

7. (canceled)

8. (canceled)

9. An electronic wallet system comprising:
a POS terminal configured to recognize a coupon stored in a terminal when using the coupon registered in a coupon server in a non-affiliated company which does not interlock with the coupon server or a service providing device and transmit a coupon number of the recognized coupon, identification information of the terminal, and unique information of the POS terminal;
an affiliated company server configured to process a usage of the coupon corresponding to the received coupon number in the coupon information corresponding to the plurality of prestored coupons and the identification information of the terminal, generate coupon processing history information of the used coupon, and transmit the generated coupon processing history information to the service providing device;
a service providing device configured to transmit the coupon processing history information transmitted from the affiliated company server to the coupon server; and
the coupon server configured to process a usage of the prestored coupon number and coupon corresponding to the identification information of the terminal included in the received coupon processing history information.

10. (canceled)

11. (canceled)

12. (canceled)
